(19) United States
(12) Patent Application Publication
(10) Pub. No.: US 2025/0304284 A1
(43) Pub. Date: Oct. 2, 2025

(54) SYSTEMS AND METHODS FOR DEPLOYABLE LINEAR STRUCTURES WITH RIVETS

(71) Applicant: Honeybee Robotics, LLC, Longmont, CO (US)

(72) Inventors: Gedi Minster, North Hollywood, CA (US); Kathryn Faye Bywaters, Monrovia, CA (US); Vishnu Sanigepalli, Los Angeles, CA (US); Robert Kenneth Van Ness, JR., Pasadena, CA (US); Brian Vogel, Simi Valley, CA (US); Hunter Williams, Denver, CO (US)

(21) Appl. No.: 19/092,767

(22) Filed: Mar. 27, 2025

Related U.S. Application Data
(60) Provisional application No. 63/571,421, filed on Mar. 28, 2024.
(60) Provisional application No. 63/701,002, filed on Sep. 30, 2024.

(51) Int. Cl. B64G 1/22; E04H 12/34

(52) U.S. Cl. CPC B64G 1/2225; E04H 12/34

(57) ABSTRACT

Deployable structures are described, in particular linearly-deployable structures, such as masts or booms. The masts may be stowed for transport and then deployed at their destination in space or on earth. A deployment system includes a storage reel storing a stowed elongate band. A drive mechanism biases and guides the band helically out of the storage reel to form an elongated mast. Adjacent edges of the deployed band may secure together using openings and corresponding protrusions, such as rivets. A welding system may use a rotating welder to weld adjacent edges of the band as it deploys. The band may be formed of multiple band segments attached together by connectors such as doublers. Protrusions such as rivets or other fasteners may attach the connectors to opposing sides of the band segments. A cylindrical space habitat or other macrostructure may be formed using multiple deployable masts that connect large rings.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. For example, this application claims the benefit of U.S. Provisional Application No. 63/571,421, filed on Mar. 28, 2024, titled DEPLOYABLE INTERLOCKING ACTUATED BANDS FOR LINEAR OPERATIONS, and U.S. Provisional Application No. 63/701,002, filed on Sep. 30, 2024, titled SYSTEMS AND METHODS FOR DEPLOYABLE LINEAR STRUCTURES WITH WELDING, DOUBLERS, AND/OR RIVETS, the entire content of each of which is incorporated by reference herein and forms a part of this specification for all purposes.

### BACKGROUND

### Field

The development relates generally to deployable structures, in particular to deployable linear structures such as elongated masts.

### Description of the Related Art

Deployable structures are useful in many contexts. For example, structures on earth are stowed for transport and then deployed at their earthly destination. Deployable structures may also be stowed for launch into space, to reduce the required volume in the launch vehicle, and then deployed in orbit or on a celestial body. Methods of forming large structures for use in space typically involve manually assembling numerous small modular parts in space. This limits the size of structures that may be assembled in space and increases the manufacturing and/or shipping costs of assembling large structures in space. Some structures may deploy automatically or by command. Such structures typically lack sufficient strength and stiffness when larger structures are needed and/or when the deployed structure supports payloads with high mass. Improvements to these and other drawbacks to deployable structures are desirable.

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing systems, devices and methods for deployable structures.

The following disclosure describes non-limiting examples of some embodiments. For instance, other embodiments of the disclosed systems and methods may or may not include the features described herein. Moreover, disclosed advantages and benefits may apply only to certain embodiments of the invention and should not be used to limit the disclosure.

Systems and methods for deployable structures, in particular linearly-deployable structures, such as masts, are described. The masts may be stowed for transport, either on earth or to outer space, and then deployed at their destination. A deployment system includes a storage reel storing a stowed elongate band in a spiral configuration. A drive mechanism biases and guides the band helically out of the plane of the storage reel to form an elongated, cylindrical mast. Adjacent edges of the band may secure together as the band deploys, using openings and corresponding protrusions, such as rivets. A welding system may weld adjacent edges of the band as it deploys. A welder may rotate about an axis of the mast during deployment. The band may be formed of multiple band segments attached together by connectors such as doublers. Protrusions such as rivets or other fasteners may attach the connectors to opposing sides of the band segments. A cylindrical space habitat or other macrostructure may be formed using multiple deployable masts that connect large rings.

In one aspect, a system for deploying a deployable mast includes an elongate band, a deployment system, and a welding system. The deployment system is configured to transition the elongate band from a stowed configuration into a helical, longitudinal deployed configuration along an axis. The welding system includes a welder configured to move relative to the axis while welding together adjacent edges of the elongate band as the elongate band transitions from the stowed configuration to the deployed configuration.

Various embodiments of the various aspects may be implemented. In some embodiments, the welder is configured to form a plurality of non-continuous weld lines when welding the adjacent edges of the elongate band. In some embodiments, the welder is further configured to rotate in a first rotational direction about the axis while welding together adjacent edges of the elongate band. In some embodiments, the welder is further configured to rotate in a second rotational direction opposite the first rotational direction after completing a weld. In some embodiments, the elongate band includes a plurality of band segments. Adjacent band segments of the plurality of band segments are coupled together by at least one connector spanning the adjacent band segments. In some embodiments, the elongate band includes a plurality of band segments. Opposing lateral sides of opposing band segments of the plurality of band segments overlap and are secured together. In some embodiments, the elongate band includes a plurality of band segments, opposing lateral sides of the plurality of band segments have respectively a series of openings and protrusions, and adjacent lateral sides of the plurality of band segments are coupled together by receiving the protrusions within the openings. In some embodiments, the deployable mast in the deployed configuration has a length of no less than 20 meters. In some embodiments, the elongate band has a linear length of no less than 90 meters. In some embodiments, the deployment system includes a rotatable reel that stores the elongate band in the stowed configuration. In some embodiments, the deployment system includes a drive system having a rotating member configured to guide the elongate band as the elongate band transitions from the stowed configuration to the deployed configuration. In some embodiments, the rotatable reel is configured to rotate at a first rate and the rotating member is configured to rotate at a second rate different than the first rate. In some embodiments, the elongate band in the stowed configuration is wound in a spiral.

In another aspect, a method of deploying a deployable mast includes feeding an elongate band from a stowed configuration to a helical, longitudinal deployed configuration along an axis. The method further includes moving a welder along adjacent edges of the elongate band as the elongate band transitions from the stowed configuration to the deployed configuration to weld the adjacent edges together.

Various embodiments of the various aspects may be implemented. In some embodiments, the method includes rotating the welder about the axis while welding the adjacent edges together. In some embodiments, the method includes rotating a storage reel at a first rate and rotating a rotating member of a drive system at a second rate different than the first rate. In some embodiments, the method includes welding a plurality of discontinuous weld lines. In some embodiments, the method includes securing adjacent portions of the elongate band together with a plurality of protrusions received within corresponding openings. In some embodiments, the method includes deploying the deployable mast, such that, in the deployed configuration, the deployable mast has a cylindrical portion with a length of no less than 20 meters. In some embodiments, the method includes deploying the deployable mast in space.

In another aspect, a system for deploying a deployable mast is described. The system includes an elongate band and a deployment system. The elongate band includes a plurality of band segments and a plurality of connectors. Pairs of the plurality of connectors couple together respective pairs of adjacent band segments of the plurality of band segments. The deployment system is configured to feed the elongate band from a stowed configuration into a longitudinal deployed configuration to form the deployable mast.

Various embodiments of the various aspects may be implemented. In some embodiments, each pair of the pairs of the plurality of connectors includes a first connector on first sides of the pair of adjacent band segments and a second connector on second, opposite sides of the pair of adjacent band segments. In some embodiments, the first sides are on radially inward sides of the pair of adjacent band segments, the second sides are on radially outward sides of the pair of adjacent band segments, and the first connector is thinner than the second connector. In some embodiments, the plurality of connectors includes a plurality of openings aligned with a respective plurality of openings in the plurality of band segments, the aligned pluralities of openings configured to receive corresponding fasteners therethrough. In some embodiments, at least one opening of the plurality of openings of the plurality of connectors has a length that exceeds a length of the respective aligned opening in a corresponding band segment of the plurality of band segments. In some embodiments, each band segment of the plurality of band segments includes a plurality of first larger width openings along a first lateral side configured to align with a plurality of second smaller width openings along a second, opposite lateral side of an adjacent band segment in the longitudinal deployed configuration. In some embodiments, in the deployed configuration, the plurality of aligned first and second openings in a first band segment are configured to receive a plurality of fasteners therethrough. In some embodiments, each band segment of the plurality of band segments has a curvature when flattened on a planar surface. In some embodiments, adjacent ends of the respective pairs of adjacent band segments include a plurality of stiffness reduction windows. In some embodiments, the elongate band in the stowed configuration is at least partially wound within a storage reel. In some embodiments, the system further includes a welding system configured to weld adjacent lateral sides of the plurality of band segments in the deployed configuration.

In another aspect, a system for deploying a deployable mast includes an elongate band and a deployment system. The elongate band includes a plurality of band segments, each band segment of the plurality of band segments extending in an elongate direction from a first end to a second end and coupled to at least one other band segment of the plurality of band segments. The first end of a first band segment of the plurality of band segments is coupled to the second end of a second band segment of the plurality of band segments by one or more connectors. The first band segment includes a first plurality of openings positioned along a first lateral edge of the first band segment that extends in the elongate direction between the first and second ends of the first band segment, a second plurality of openings positioned along a second lateral edge of the first band segment that is opposite the first lateral edge and that extends in the elongate direction between the first and second ends of the first band segment, and a third plurality of openings positioned at or near the first end of the first band segment, the third plurality of openings configured to reduce a stiffness of the first end of the first band segment. The deployment system is configured to feed the elongate band to form the deployable mast longitudinally along an axis.

Various embodiments of the various aspects may be implemented. In some embodiments, the elongate band is configured to be wound within a storage reel, and the deployment system is further configured to feed the elongate band out of the storage reel. In some embodiments, the first and second lateral edges of the first band segment are curved when the first band segment is flattened on a planar surface. In some embodiments, the one or more connectors includes a first connector and a second connector, and the first end of the first band segment is coupled to the second end of the second band segment by the first connector being coupled to a first surface of the first band segment and a first surface of the second band segment and the second connector being coupled to a second surface of the first band segment and a second surface of the second band segment. The first surface of the first band segment and the first surface of the second band segment face in a first direction, and the second surface of the first band segment and the second surface of the second band segment face in a second direction opposite that of the first direction. In some embodiments, the first connector has a thickness that is less than a thickness of the second connector.

In another aspect, a method of deploying a deployable mast is described. The method includes feeding an elongate band including a plurality of band segments coupled together by one or more connectors to form the deployable mast. The method also includes joining adjacent lateral edges of the elongate band as the elongate band forms the deployable mast.

Various embodiments of the various aspects may be implemented. In some embodiments, the method includes rotating a storage reel at a first rate and rotating a rotating member of a drive system at a second rate different than the first rate. In some embodiments, the method includes welding together adjacent lateral edges of the elongate band as the deployable mast is formed. In some embodiments, the one or more connectors includes two connectors and the method further includes sliding at least one of the two connectors along the plurality of band segments.

In another aspect, a deployable structure includes a first ring, a second ring, and a plurality of deployable masts. The first ring includes a first plurality of ribs extending radially inward toward a longitudinal axis of the first ring. The second ring includes a second plurality of ribs extending radially inward toward a longitudinal axis of the second ring. Each deployable mast is coupled at a first end to the first ring and at a second, opposite end to the second ring. The plurality of deployable masts are configured to helically and longitudinally deploy along respective axes to increase a distance between the first ring and the second ring.

Various embodiments of the various aspects may be implemented. In some embodiments, the first plurality of ribs and the second plurality of ribs each include deployable masts configured to deploy radially inward toward a respective central hub. In some embodiments, the first plurality of ribs and the second plurality of ribs each include deployable masts configured to deploy radially outward from a respective central hub. In some embodiments, each deployable mast of the plurality of deployable masts are configured to deploy at a same rate. In some embodiments, each deployable mast of the plurality of deployable masts are configured to deploy by feeding an elongate band from a spiral configuration in a plane to a longitudinal configuration extending along the respective axes that are perpendicular to the plane. In some embodiments, each deployable mast of the plurality of deployable masts includes a plurality of band segments connected together by one or more connectors. In some embodiments, the deployable structure includes one or more welders configured to weld together adjacent edges of an elongate band that forms the deployed mast of each deployable mast of the plurality of deployed masts. In some embodiments, each deployable mast of the plurality of deployable masts includes an elongate band. The elongate band includes a series of openings configured to receive a series of protrusions. In some embodiments, the plurality of rings each have a diameter of at least 3 meters and, in the deployed configuration, a longitudinal distance between the first ring and the second ring is at least 70 meters.

In another aspect, a deployable structure includes a plurality of rings and a plurality of deployable masts. Each deployable mast is coupled at a first portion to a first ring of the plurality of rings and at a second portion to a second ring of the plurality of rings. Each deployable mast of the plurality of deployable masts is configured to helically feed an elongate band from a stowed configuration to a longitudinal, deployed configuration.

Various embodiments of the various aspects may be implemented. In some embodiments, the elongate band includes a series of holes and a series of protrusions, with each hole configured to receive a respective one of the protrusions as the elongate band is fed from the stowed configuration to the longitudinal, deployed configuration. In some embodiments, the deployable structure includes a welding system configured to weld together adjacent edges of the elongate band as the elongate band is fed from the stowed configuration to the longitudinal, deployed configuration. In some embodiments, the plurality of rings each have a diameter of at least 3 meters. In some embodiments, in the deployed configuration, a longitudinal distance between the first ring and the second ring is at least 70 meters.

In another aspect, a method of deploying a deployable structure includes transitioning a first elongate band from a spiral, stowed configuration in a first plane to a deployed helical configuration forming a cylinder extending axially and perpendicular to the first plane. The method also includes transitioning a second elongate band from a spiral, stowed configuration in a second plane to a deployed helical configuration forming a cylinder extending axially and perpendicular to the second plane. The method also includes longitudinally separating a first ring from a second ring in response to transitioning the first and second elongate bands to the respective deployed helical configurations.

Various embodiments of the various aspects may be implemented. In some embodiments, the method includes feeding the first and second elongate bands out of respective rotating storage reels. In some embodiments, the method includes welding adjacent edges of each of the elongate bands together as the elongate bands transition to the stowed configuration. In some embodiments, the method includes receiving protrusions of each of the elongate bands into respective openings of the elongate bands as the elongate bands transition to the stowed configuration. In some embodiments, the method includes longitudinally separating the first ring at least 70 meters from the second ring. In some embodiments, the method includes rotating a storage reel and a rotating member of a drive system at different rotational rates to transition the first elongate band to the deployed configuration.

In another aspect, a system for deploying a deployable mast includes an elongate band and a deployment system. The elongate band includes a plurality of openings and a plurality of protrusions. The deployment system is configured to deploy the elongate band from a stowed configuration into a deployed, helical configuration along a longitudinal axis in which the plurality of protrusions extend into the plurality of openings.

Various embodiments of the various aspects may be implemented. In some embodiments, the plurality of openings and protrusions are configured to have a press fit or interference fit. In some embodiments, each opening of the plurality of openings includes a first bore having a first width and a second bore having a second width, the second width smaller than the first width. In some embodiments, the plurality of protrusions are spaced along a first lateral side of the elongate band, and the plurality of openings are spaced along a second, opposite lateral side of the elongate band. In some embodiments, the elongate band includes a plurality of band segments, with adjacent band segments of the plurality of band segments coupled together by at least one connector. In some embodiments, the at least one connector includes openings and is coupled with the adjacent band segments via the plurality of protrusions of the adjacent band segments extending into the openings of the at least one connector. In some embodiments, the elongate band includes a plurality of band segments, adjacent band segments of the plurality of band segments coupled together by securing an end of a first band segment to an end of a second band segment, the end of the first band segment overlapped with the end of the second band segment. In some embodiments, the elongate band is wound in a spiral when in the stowed configuration. In some embodiments, the system includes a welding system configured to weld adjacent edges of the elongate band as the elongate band deploys from the stowed configuration to the deployed configuration. In some embodiments, the deployment system comprises a storage reel and a drive system having a rotating member, wherein the storage reel rotates at a first rate and the rotating member rotates at a second rate different than the first rate. In some embodiments, the elongate band in the deployed configuration comprises a cylindrical portion extending no less than 20 meters. In some embodiments, the elongate band includes a plurality of band segments. Ends of the band segments include stiffness reduction windows.

In another aspect, a method of deploying a deployable mast includes feeding an elongate band from a stowed configuration to a deployed, helical configuration extending along a longitudinal axis. The method also includes receiving a plurality of protrusions spaced along a first portion of the elongate band into a plurality of openings spaced along a second portion of the elongate band as the elongate band is fed into the deployed configuration.

Various embodiments of the various aspects may be implemented. In some embodiments, the method includes press fitting or interference fitting the plurality of protrusions with the plurality of openings. In some embodiments, the method includes receiving the plurality of protrusions into a first bore of the plurality of openings that is wider than a second bore of the plurality of openings and then receiving the plurality of protrusions into the second bore. In some embodiments, the method includes withdrawing the plurality of protrusions from the plurality of openings while feeding the elongate band from the deployed configuration back to the stowed configuration. In some embodiments, the method includes rotating a storage reel at a first rate and rotating a rotating member of a drive system at a second rate different than the first rate to thereby feed the elongate band. In some embodiments, the method includes feeding the elongate band from a spiral, stowed configuration to the deployed configuration. In some embodiments, the method includes welding adjacent edges of the first portion of the elongate band and the second portion of the elongate band. In some embodiments, the method includes deploying the deployable mast to have a cylindrical portion extending along the longitudinal axis no less than 20 meters.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawing, may be arranged, substituted, combined, and designed in a wide variety of different configurations, all of which are explicitly contemplated and make part of this disclosure.

FIG. 1 illustrates an embodiment of a system including a deployment systema and a deployable mast in a deployed configuration supporting a solar array;

FIGS. 2A and 2B illustrate an embodiment of a deployment system for deploying a deployable mast, that may be used in the system of FIG. 1, and shown in, respectively, a vertical and a horizontal orientation;

FIG. 3A illustrates various components of the deployment system of FIG. 1 in an unassembled state;

FIG. 3B is an exploded view of the deployment system of FIG. 1;

FIG. 4 illustrates an embodiment of a rotating member and a static member of a drive system that may be used with the deployment system of FIG. 1;

FIG. 5A illustrates a side cross-sectional view of the deployment system of FIG. 1;

FIG. 5B illustrates an embodiment of a housing that may be used with the deployment system of FIG. 1;

FIG. 6A illustrates a perspective view of an embodiment of a deployable mast in a partially deployed configuration that may use the deployment system of FIG. 1;

FIGS. 6B and 6C illustrate an embodiment of the deployment system of FIG. 1 being used, respectively, to deploy and stow a deployable mast;

FIG. 7 illustrates an embodiment of a band segment of an elongate band that may be used with the deployment systems of FIG. 1;

FIGS. 8A and 8B illustrate an embodiment of adjacent band segments and connectors that may be used with an elongate band of the deployment system of FIG. 1;

FIG. 9 illustrates an embodiment of a connector that may be used in coupling the adjacent band segments of FIGS. 8A and 8B;

FIG. 10 illustrates a close-up view of example aligned openings in a connector and a band segment that may be used with the band segments of FIGS. 8A and 8B, where the connector opening has a slot-like shape;

FIGS. 11A and 11B illustrate embodiments, respectively, of inner and outer connectors coupling adjacent band segments in a non-deployed configuration that may be used with the band segments of FIGS. 8A and 8B;

FIGS. 11C and 11D illustrate embodiments, respectively, of inner and outer connectors coupling adjacent band segments in a deployed configuration;

FIGS. 12A-12C illustrate an embodiment of coupled adjacent band segments with connectors that that may be used with the band segments of FIGS. 8A and 8B;

FIG. 13 illustrates an embodiment of coupled adjacent band segments having overlapping portions that that may be used with the band segments of FIGS. 8A and 8B;

FIG. 14A illustrates an embodiment of a system and method for joining adjacent edges of an elongate band using a welding system that may be used with any of the elongate bands described herein;

FIGS. 14B and 14C illustrate example weld lines used in joining adjacent edges of an elongate band;

FIGS. 14D and 14E illustrate example joints that may be formed by welding adjacent edges of an elongate band;

FIGS. 15A-15E illustrate example methods of installing protrusions shown as rivet assemblies that may be used with any of the elongate bands or connectors described herein;

FIG. 16 illustrates a perspective view of an embodiment of a deployable structure including a plurality of deployable masts connecting a plurality of rings shown in a deployed configuration; and

FIG. 17 illustrates an end view of the deployable structure of FIG. 16 in a launch configuration.

### DETAILED DESCRIPTION

The following detailed description is directed to certain specific embodiments for devices, systems, and methods related to deployable masts and deployable structures. In this description, reference is made to the drawings wherein like parts or steps may be designated with like numerals throughout for clarity. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments. Reference will now be made in detail to embodiments of the invention, examples of which are illustrated in the accompanying drawings. Wherever possible, the same reference numbers will be used throughout the drawings to refer to the same or like parts.

The systems and methods according to the present disclosure relate to deployable structures that may deploy an elongate band to form a rigid, cylindrical structure, such as a mast that extends along a longitudinal axis. While the deployable systems are shown and described herein in the context of deploying deployable masts, it is understood the deployable systems may be used to deploy other structures besides masts, such as tubes, booms, cylinders, etc. In some instances, the deployable masts may be used to form large deployable structures, for example space habitats, or other large structures to be stowed for launch to space and deployment in space. In some instances, the deployed mast may be retracted from a deployed configuration and returned to a stowed configuration. In some instances, the deployed mast may be permanently deployed (e.g., not capable of being retracted). In some instances, the deployable masts may be at least 15 meters in length when deployed.

The systems and methods according to the present disclosure provide many benefits and advantages. For example, in the space context, the deployable masts and structures described herein may be stowed in a launch configuration for sending to space. This may be advantageous as it may reduce the size of the mast or structure being sent to space, while also allowing for larger space structures and habitats to be built using more efficient processes. Further, existing deployable structures do not have sufficient load-bearing capabilities for certain applications. In contrast, the structures, systems, and methods according to the present disclosure provide for structures and systems with high strength capabilities, allowing for applications requiring such capabilities. The deployable masts may be beneficial for deep drilling, high lifting, supporting other components like solar arrays, and other applications. In some embodiments, the deployable masts may provide an open bore extending through the mast that may be used to feed cables to an end effector or serve as a media for material transport.

The systems may use rotating components, such as a housing and reel, to cause a stowed elongate band to assume an elongated structure extending along the longitudinal axis. The elongate band may be stowed in a spiral configuration, and it may helically deploy into the elongated structure. The band may include connectors such as doublers that secure together multiple segments of the band. The connectors may be secured with the band segments using protrusions such as rivets or other fasteners. A welding system may include a welder that welds the joints of the elongate band as the band deploys. Corresponding openings and protrusions along the elongate band may secure together to align and form the elongate structure. The openings may be strategically sized and located to facilitate deployment and engagement of the various connections and to control stiffness. These and other features of the deployable structures provide for the above and other capabilities, as further described herein.

### Example Application of Deployment System

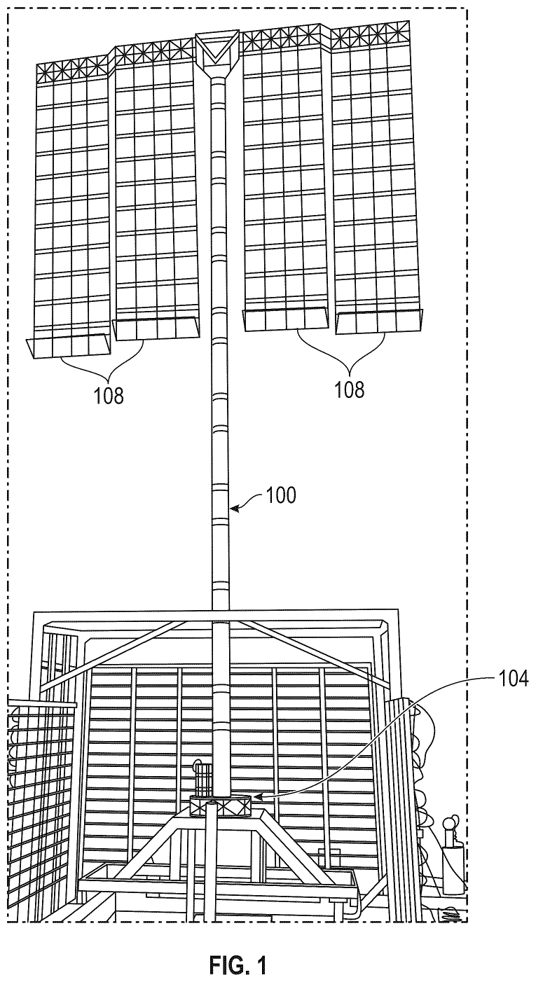

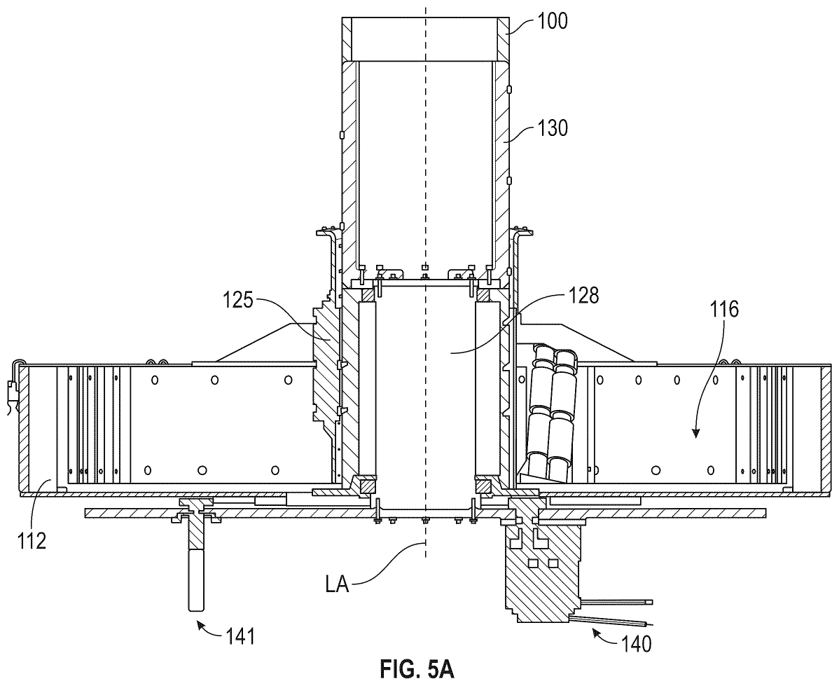

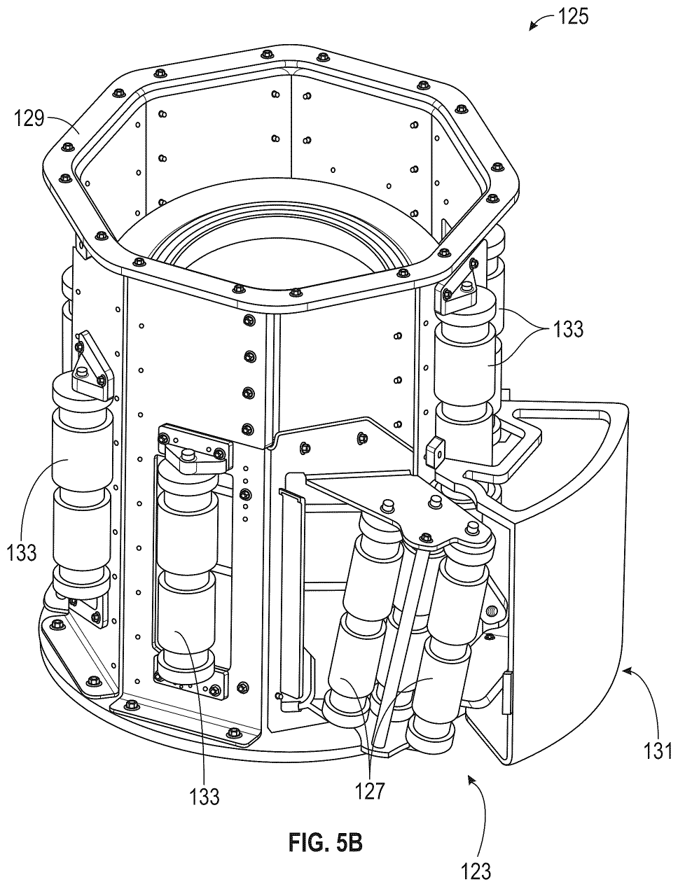

FIG. 1 illustrates an embodiment of a system including a deployable mast 100 extending from a deployment system 104 and supporting a payload 108 shown as a deployed solar array. The deployable mast 100 is shown in a deployed configuration. The deployable mast 100 may be deployed through the use of the deployment system 104 at the base of the deployable mast 100. The deployable mast 100 may have an elongate band (e.g., an elongate band 116 of FIG. 5A) wound in a spiral shape when stowed and wound helically or helicoidally to form a longitudinally extended cylinder when deployed. A transverse plane may intersect the stowed elongate band and be perpendicular to a direction of deployment of the deployable mast 100. The deployable mast 100 may deploy out of the plane of the stowed elongate band. The deployable mast 100 may have a constant diameter along a length of the deployable mast 100 in the deployed configuration.

The deployable mast 100 may support one or more of the payloads 108. FIG. 1 illustrates the deployable mast 100 supporting the payload 108 at an upper end of the upwardly deployed deployable mast 100. The payload 108 comprises a plurality of solar panels extending from opposing sides of the deployable mast 100. The deployable mast 100 may deploy horizontally or non-vertically, for example to form a boom supporting one or more payloads along the length thereof. Other non-limiting examples of payloads 108 include power sources, communication sources, or navigation nodes. The payloads 108 may generate power, facilitate communication with other lunar systems or Earth, or provide navigation support for lunar operations. Any of the features of any systems, devices, and methods described herein may use, or be used with, the system of FIG. 1.

### Example Deployment Systems

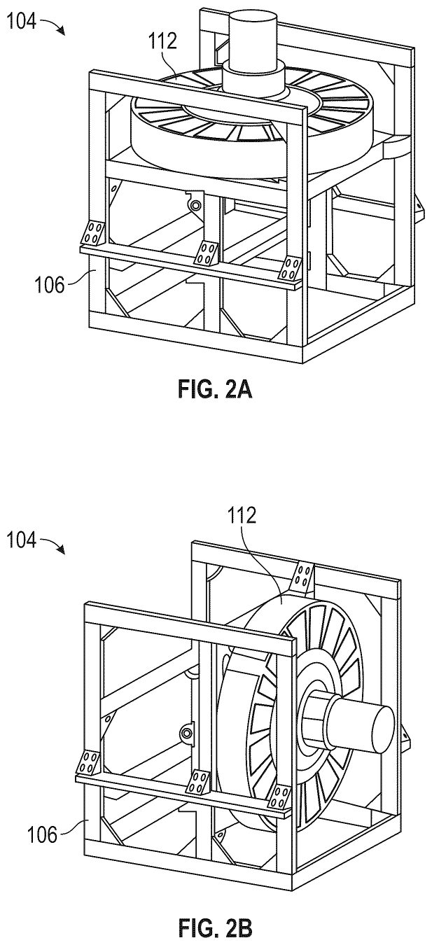

FIGS. 2A and 2B illustrate an embodiment of the deployment system 104 that may be used with the system of FIG. 1. FIG. 2A illustrates the deployment system 104 in a vertical configuration and FIG. 2B illustrates the deployment system 104 in a horizontal configuration. The deployment system 104 may be coupled with a support structure 106. The support structure 106 may orient the deployment system 104 in the vertical configuration or the horizontal configuration. The support structure 106 may be used to secure the deployment system 104 to a deployment site, for example, a surface or structure where the deployment system 104 may be used to deploy the deployable mast 100 in either configuration.

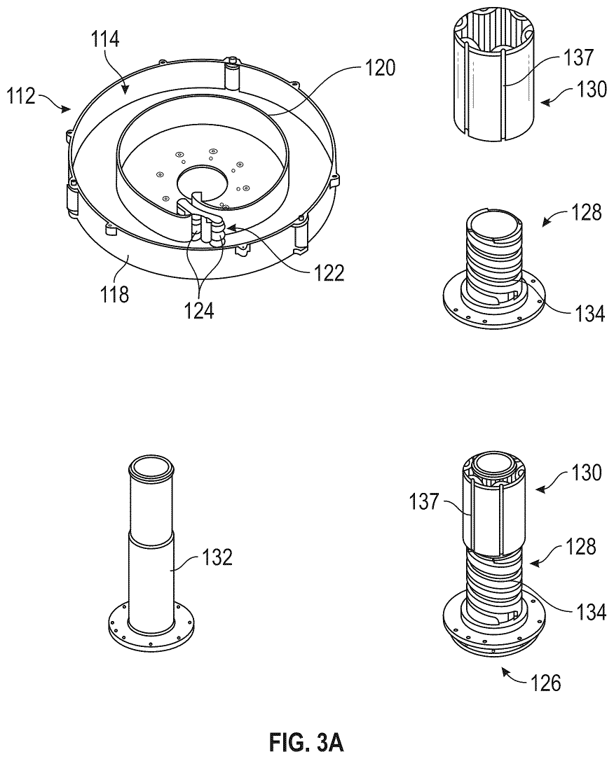

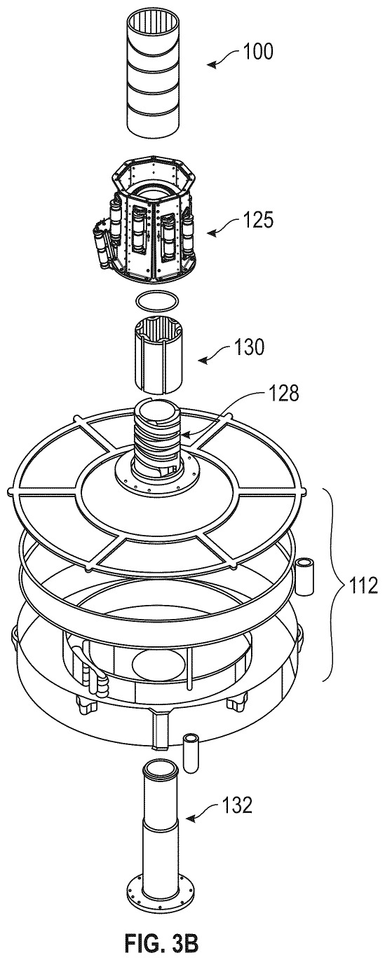

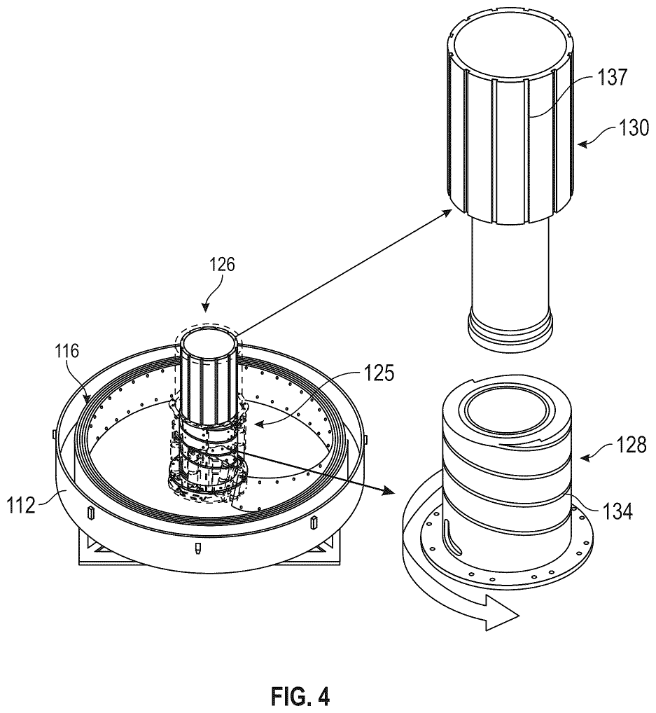

FIGS. 3A-5B illustrate various views and various features of the deployment system 104 that may be used with any of the deployment systems described herein. FIG. 3A illustrates various components of the deployment system 104 in an unassembled state. FIG. 3B is an exploded view of the deployment system 104. FIG. 4 illustrates an embodiment of a rotating member and a static member of a drive system that may be used with the deployment system 104. FIG. 5A illustrates a side cross-sectional view of the deployment system 104. FIG. 5B illustrates an embodiment of a housing that may be used with the deployment system 104.

The deployment system 104 may deploy an elongate band 116 (see, e.g., FIG. 5A) from a stowed configuration into a deployed, helical configuration along a longitudinal axis LA of the deployable mast 100 (such as the deployed configuration shown in FIG. 1). The deployment system 104 may be configured to feed, e.g. push, slide, or bias, the elongate band 116 helically to form the mast and extend the mast linearly along the longitudinal axis of the deployable mast 100. The elongate band 116 may be fed to form the deployed mast with one or more rotating components of the deployment system (as further describe herein) but without rotating a cylindrical, deployed portion of the deployable mast 100 about the longitudinal axis. Thus the cylindrical portion of the deployed mast may remain rotationally stationary as it deploys linearly.

The deployment system 104 may include a storage reel 112. The storage reel 112 may be rounded, e.g. cylindrical or circular as shown. The storage reel 112 may store the elongate band 116 in a stowed configuration. The elongate band 116 may be wound in a spiral in the stowed configuration. A diameter of the storage reel 112 and/or stowed elongate band 116 may have any size outer diameter. The outer diameter may be scaled depending on the intended length of the deployed deployable mast 100. For example, a storage reel 112 and/or stowed elongate band 116 for a deployable mast 100 having a shorter length may have a smaller diameter than a storage reel 112 and/or stowed elongate band 116 for a deployable mast 100 having a longer length. In some instances, the storage reel 112 and/or stowed elongate band 116 may have an outer diameter from 0.02 meters to 1.0 meter, or more or less, or any value in between. The elongate band 116 may be fed out of the storage reel 112 to deploy the deployable mast 100. The deployed deployable mast 100 may have an elongated, longitudinal length from 2 meters to 20 meters, any value in between 2 meters and 20 meters, at least 2 meters, at least 5 meters, at least 10 meters, at least 15 meters, or at least 20 meters. The deployed deployable mast 100 can have an indefinite length. For example, when used in a zero-gravity environment there may be no constraints on length. The size of the storage reel 112 and the length of the elongate band 116 can be increased to allow for storage and deployment of a deployed deployable mast 100 of any length. This length may be the axial length of the cylindrical portion of the deployed mast.

The elongate band 116 may be stored in a storage area 114 of the storage reel 112. The storage reel 112 and the storage area 114 can be scaled based on the dimensions of the elongate band 116. For example, the longer the elongate band 116 the larger the storage reel 112 (e.g., the diameter of the storage reel 112) may need to be. In some embodiments, the elongate band 116 may be partially wound within the storage reel 112. The storage area 114 may be defined by an outer wall 118 and an inner wall 120. The inner wall 120 may include an inlet 122 for feeding the elongate band 116. The inlet 122 may include a plurality of rollers 124 to assist in feeding the elongate band 116.

The deployment system 104 may include a housing 125 (see, e.g. FIGS. 3B and 5B). The housing 125 may provide support to the deployable mast 100 during and after deployment. The housing 125 may assist in guiding the elongate band 116 to form the deployable mast 100 during the deployment process. The housing 125 may include a stiffener section 129 at a deployment end of the housing 125 (e.g., where the elongate band 116 is fed out of the housing 125). The stiffener section 129 may provide support to the deployable mast 100 as it deploys. The stiffener section 129 may assist in maintaining the intended shape of the deployable mast 100.

As shown in FIG. 5B, the housing 125 may include a passive feeder 123. The passive feeder 123 may assist in aligning the elongate band 116 when being fed into the drive system 126. The passive feeder 123 may include a plurality of inlet rollers 127. The elongate band 116 may be fed through a guide 131 and between the plurality of inlet rollers 127. The elongate band 116 may first extend through the guide 131 and then between the plurality of inlet rollers 127. The elongate band 116 may then be fed into an interior space of the housing 125.

The housing 125 may have a second plurality of rollers 133 positioned about an outer wall of the housing 125 (see, e.g., FIG. 5B). The second plurality of rollers 133 may be positioned in openings of the outer wall of the housing 125 such that a portion of each roller of the second plurality of rollers 133 rotates within the outer wall of the housing 125. The second plurality of rollers 133 may support an outer diameter of lower portion of the deployable mast 100 as it deploys. The second plurality of rollers 133 may prevent the elongate band 116 from springing out of the housing 125 as the deployable mast 100 deploys. The second plurality of rollers 133 may prevent band segments of the elongate band 116 from separating as the deployable mast 100 deploys, for example band segments 150, 200 discussed in more detail below.

The guide 131 and the passive feeder 123 including the plurality of inlet rollers 127 may assist in feeding the elongate band 116 into a drive system 126 (see, e.g., FIGS. 3A-5A). The drive system 126 may be positioned at least partially within the housing 125. The drive system 126 may include a rotating member 128 and a static member 130. In some embodiments, the static member 130 may extend at least partially out of an upper, deployment end of the housing 125. In some embodiments, the drive system 126 may include a structural support 132. The structural support 132 may be a separate piece from the rotating member 128 and the static member 130, or the structural support 132 may be part of the rotating member 128 and/or the static member 130. The drive system 126 may be configured to feed the elongate band 116 out of the storage reel 112, through the housing 125 and into the deployed configuration of the deployable mast 100.

The drive system 126 may be powered by a motor 140 (see, e.g., FIG. 5A). The motor 140 may cause the rotating member 128 and/or storage reel 112 to rotate. In some embodiments, the motor 140 may be a brushless DC motor. The drive system 126 and the elongate band 116 may comprise the same material to reduce any potential issues with differences in coefficient of thermal expansion. Non-limiting example materials include aluminum, steel, composites, and plastics.

The rotating member 128 may include a track 134 (see, e.g., FIG. 3A). The track 134 may be a helical track formed in an outer surface of the rotating member 128. The track 134 may extend along the outer surface of the rotating member 128 from a first end of the rotating member 128 to a second end of the rotating member 128. The track 134 may assist in guiding the elongate band 116 during deployment of the deployable mast 100 as described herein.

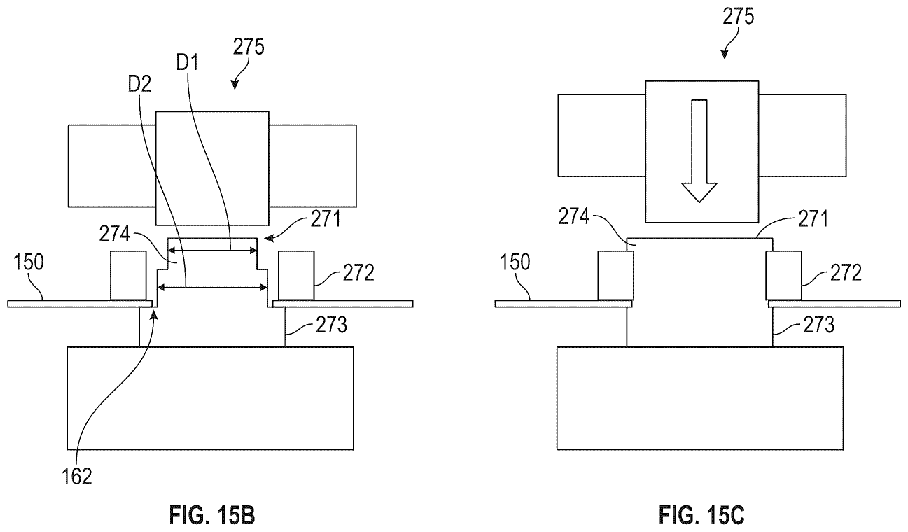

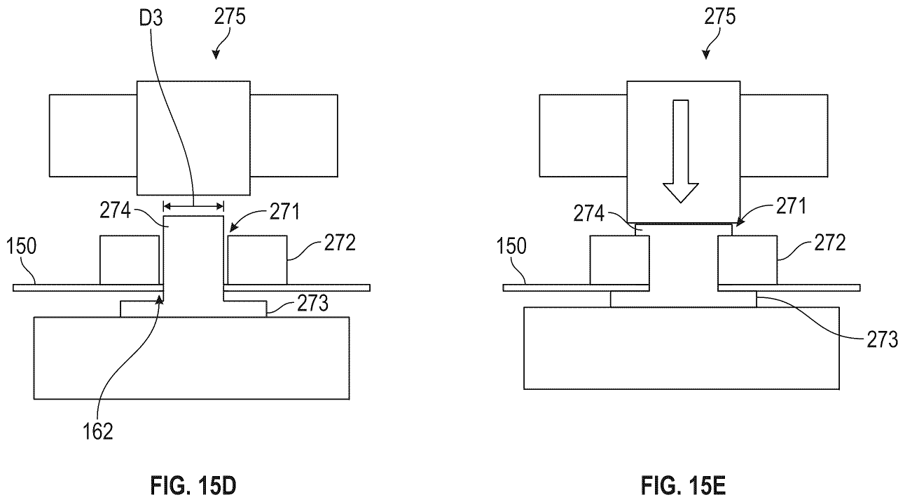

An embodiment of the elongate band 116 may include protrusions, for example fasteners such as pre-assembled rivet assemblies (e.g., the protrusions 270 of FIGS. 15A-E embodied as rivet assemblies). Portions of the protrusions 270 may align and rest within the track 134. As the rotating member 128 rotates, the track 134 may guide the elongate band 116 into a helically and longitudinally wound configuration through the interaction between the track 134 and the protrusions 270. A first portion of each protrusion 270 may rest within the track 134 while a second portion of each protrusion 270 extends through an opening in the elongate band 116. The protrusions are described in further detail herein, for example with reference to FIGS. 15A-E.

The static member 130 may be coupled with the rotating member 128 (see, e.g., FIG. 3A). The static member 130 may include a plurality of slots 137 extending in a longitudinal direction. The static member 130 may provide reaction as the rotating member 128 and the track 134 rotate or spin. The static member 130 can assist in reacting external moment loads, for example, payload, gravity, or solar loads. The plurality of slots 137 can assist in guiding the pre-assembled rivet assemblies during deployment.

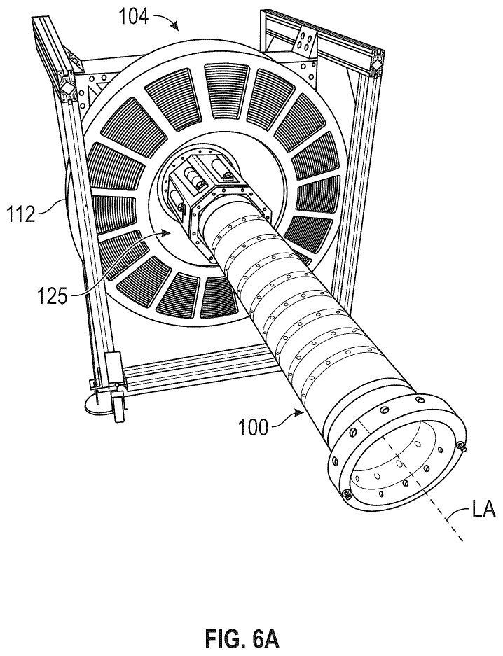

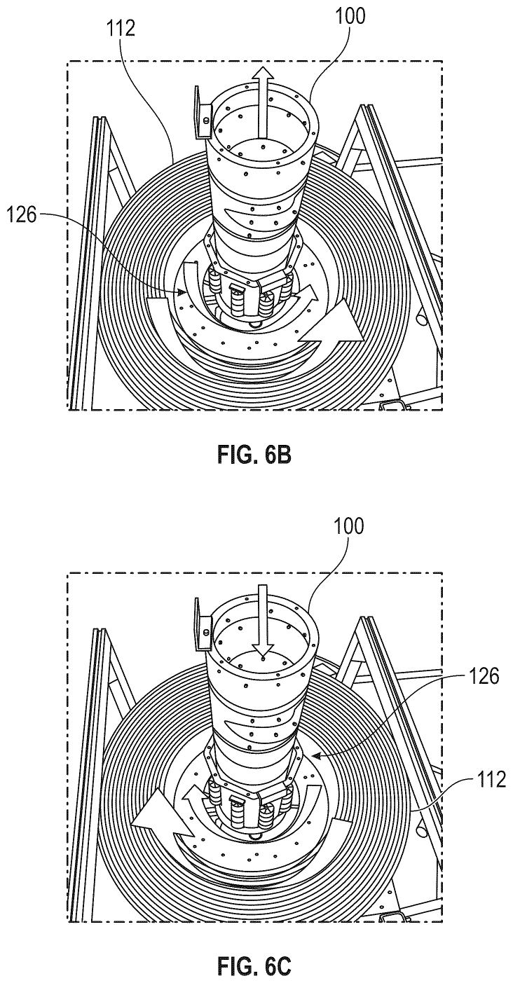

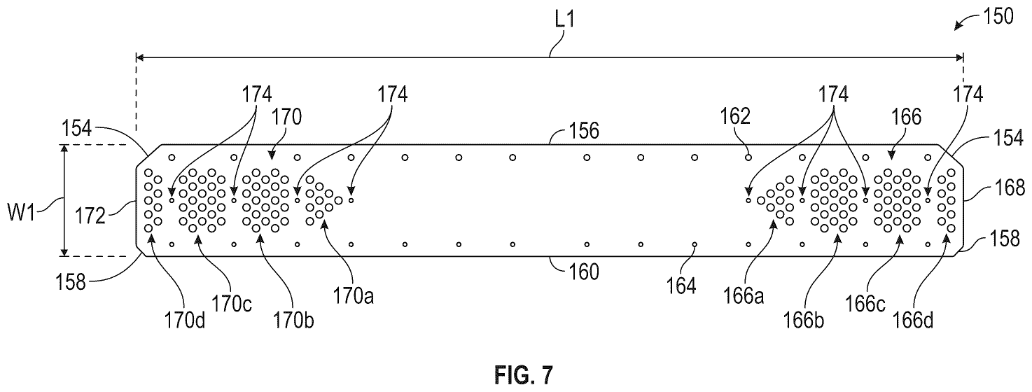

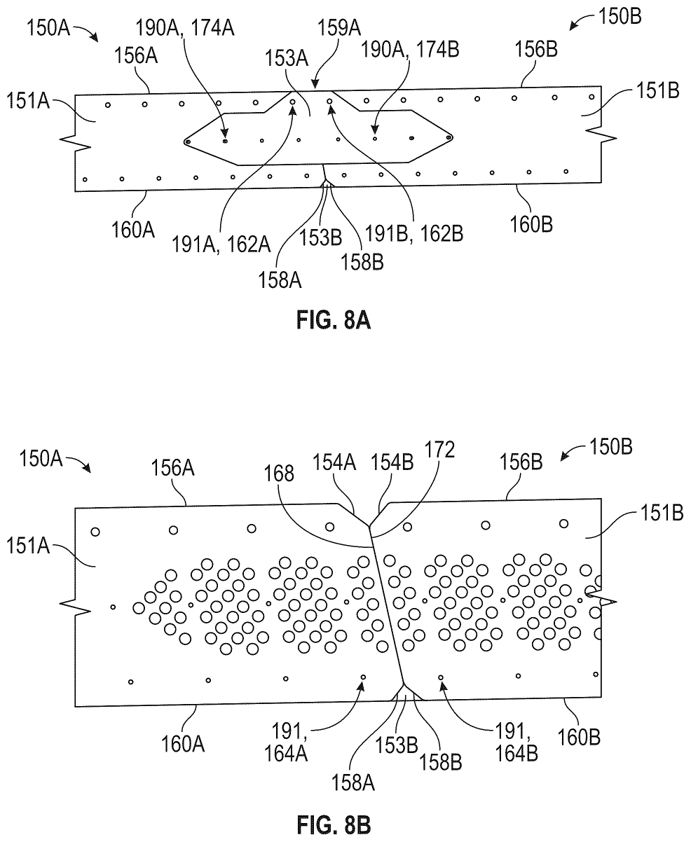

During deployment of the elongate band 116, the rotating member 128 of the drive system 126 and the storage reel 112 may rotate to feed and deploy the elongate band 116. The rotation of the rotating member 128 may be driven by the motor 140 of the drive system 126, as shown in FIG. 5A. The rotation of the storage reel 112 may be driven passively by the rotation of the rotating member 128 or may be independently actuated by a second motor 141, as shown in FIG. 5A. The storage reel 112 may have an independent degree-of-freedom of rotation from the drive system 126. The rotation of the rotating member 128 and the storage reel 112 may feed the elongate band 116 from the storage reel 112 to create a helically overlapped structure that is driven along the longitudinal axis LA and out of the housing 125, for example as shown in FIGS. 6A and 6B. FIG. 6A illustrates a perspective view of an embodiment of a deployable mast in a partially deployed configuration that may use the deployment system 104. The deployment system 104 may include one or more sensors to monitor the deployment of the elongate band 116 and correct potential misalignment of the elongate band 116 as the deployable mast 100 is being deployed. The sensors may be optical sensors or cameras. The sensors may monitor protrusion (e.g., the protrusions 270 of FIGS. 15A-E embodied as rivet assemblies) and opening (e.g., openings of the band segments of FIGS. 7-8B) alignment during deployment. If the sensors detect misalignment, the motor 140 may stop so the problem (e.g., the misalignment) can be addressed.

Due to the difference in the spiral geometry of the elongate band 116 when stowed in the storage reel 112 and the final diameter of the deployable mast 100, the storage reel 112 may rotate at a different speed than the rotating member 128 of the drive system 126. The storage reel 112 may rotate at a first rate and the rotating member 128 may rotate at a second rate different than the first rate. In some embodiments, the storage reel 112 may rotate at a slower speed than the rotating member 128. The relative speed of the rotating member 128 and the storage reel 112 may be based on the length of a deployed deployable mast 100, a diameter of the deployed deployable mast 100, and a helical pitch of the deployed deployable mast 100.

FIGS. 6B and 6C illustrate an embodiment of the deployment system 104 being used, respectively, to deploy and stow a deployable mast. FIG. 6B illustrates the deployment system 104 being used to deploy the deployable mast 100 into the deployed configuration. In some embodiments, the deployment system 104 may be used to both deploy and retract the deployable mast 100, as described in more detail herein. The direction of the rotation of the drive system 126 and storage reel 112 during deployment will be opposite the direction of the rotation during retraction.

FIG. 6C illustrates the deployment system 104 being used to retract the deployable mast 100 into a retracted configuration. In other embodiments, the deployment system 104 may only be used to deploy the deployable mast 100 as will be described in more detail below. For example, the deployable mast 100 may not be capable of being retracted due to permanent joining of adjacent edges of the elongate band 116. The one or more motors 140, 141 may cause the storage reel 112 and/or the rotating member 128 to rotate in first rotational directions to deploy the deployable mast 100, and in second, opposite rotational directions to retract the deployable mast 100.

### Example Elongate Bands and Connectors

FIG. 7 illustrates an embodiment of a band segment 150 of the elongate band 116 shown in a flat configuration and that may be used with the deployment system 104 or any other deployment system described herein. As described herein, the storage reel 112 may store the elongate band 116. The elongate band 116 may include a plurality of the band segments 150 coupled together. The band segments 150 may be manufactured out of sheet metal, for example, by laser cutting, CNC milling, or chemical etching.

The band segment 150 may have a first surface 151 and a second surface opposite the first surface. The band segment 150 may have a length L1 and a width W1. The band segment 150 is elongated in the longitudinal direction forming the length L1 with a transverse width W1 that is less than the length L1. The length L1 may be more than twice, more than three times, more than four times, or more than five times the width W1.

The band segment 150 may have one or more chamfered corners 154, 158. The chamfered corners 154 at the ends of a first lateral edge 156 of the band segment 150 may be chamfered to a greater degree than the chamfered corners 158 at the ends of a second lateral edge 160 of the band segment 150. For example, the length of the angled, chamfered portion of the chamfered corners 154 may be greater than the length of the angled, chamfered portion of the chamfered corners 158. The chamfered corners 154, 158 may help in reducing the stiffness at connection points between ends of adjacent band segments 150.

While the band segment 150 is shown straight in FIG. 7, in some embodiments, the band segment 150 when laid flat on a planar surface may have an arc or curvature. The arc or curvature may allow for the band segment 150 to self-interlap as it is helically deployed in the deployable mast 100 and form the cylindrical or other elongated structure of the mast. As shown, the first lateral edge 156 and the second lateral edge 160 are straight. In some embodiments, the first lateral edge 156 and the second lateral edge 160 may be curved when the band segment 150 is flattened on a planar surface.

The band segment 150 may include a first series or plurality of openings 162 formed along the first lateral edge 156 and extending in an elongate direction between the ends 168, 172 of the band segment 150. The band segment 150 may include a second series or plurality of openings 164 positioned along the second lateral edge 160 and extending in the elongate direction between the ends 168, 172 of the band segment 150. The openings 162, 164 may be in rows as shown. The openings 162, 164 may be circular holes as shown. The first plurality of openings 162 and the second plurality of openings 164 may be the same size or be different sizes. For example, the first plurality of openings 162 may be larger than the second plurality of openings 164. The first plurality of openings 162 and the second plurality of openings 164 may be spaced at intervals such that each hole of the first plurality of openings 162 aligns with a corresponding hole of the second plurality of openings 164.

The first and second plurality of openings 162, 164 may assist in connecting laterally adjacent band segments 150 together as the mast is formed, as described in further detail herein. Each of the first plurality of openings 162 may be configured to couple with a corresponding protrusion, for example a fastener such as a rivet assembly (as described in further detail herein, for example with reference to FIGS. 15A-E). The protrusion may be pre-installed prior to storing of the elongate band 116 in the storage reel 112. Each of the second plurality of openings 164 may be configured to receive a shaft of the protrusion during deployment of the deployable mast 100 to align the adjacent edges. In some embodiments, the protrusions may be integral with the band segment, such that the band segment does not include open spaces at one of the openings 162 or 164, but rather includes protruding pins, bumps, raised surfaces, or other raised features in those locations that engage with the other of the openings 162 or 164.

The band segment 150 may include a third plurality of openings 166 positioned at or near a first end 168 of the band segment 150. The third plurality of openings 166 may reduce a stiffness of the band segment 150 at the first end 168. The third plurality of openings 166 may create a first stiffness reduction window. The third plurality of openings 166 may be configured to provide a gradual change in stiffness at or near the first end 168 of the band segment 150, such as a decrease in stiffness in a direction toward the edge.

The third plurality of openings 166 may include one or more sets of openings, such as a first set of openings 166a, a second set of openings 166b, a third set of openings 166c, and a fourth set of openings 166d. The first set of openings 166a may form a generally triangular shape. The first set of openings 166a may be positioned farthest away from the first end 168 of the band segment 150 as compared to the second set of openings 166b, the third set of openings 166c, and the fourth set of openings 166d. The second set of openings 166b may form a generally rectangular shape and be positioned adjacent and between the first set of openings 166a and the second set of openings 166c. The second set of openings 166b may be more numerous and/or have more open area than the first set of openings 166a. The third set of openings 166c may form a generally rectangular shape. In some embodiments, the third set of openings 166c may have an identical arrangement to the second set of openings 166b. The third set of openings 166c may be more numerous and/or have more open area than the first set of openings 166a. The third set of openings 166c may be positioned adjacent and between the second set of openings 166b and the fourth set of openings 166d. The fourth set of openings 166d may form a generally rectangular shape that has a smaller width than the generally rectangular shape of the second and third sets of openings 166b, 166c. The fourth set of openings 166d may be less numerous and/or have less open area than the second and/or third sets of openings 166b, 166c. The fourth set of openings 166d may be positioned adjacent and between the third set of openings 166c and the first end 168 of the band segment. Each of the openings may extend completely through the band segment 150.

The band segment 150 may include a fourth plurality of openings 170 positioned at or near a second end 172 of the band segment 150. The fourth plurality of openings 170 may have an arrangement that generally mirrors that of the third plurality of openings 166. The fourth plurality of openings 170 may reduce a stiffness of the band segment 150 at the second end 172. The fourth plurality of openings 170 may create a second stiffness reduction window. The fourth plurality of openings 170 may be configured to provide a gradual change in stiffness at or near the second end 172 of the band segment 150, etc. The fourth plurality of openings 170 may include a first set of openings 170a, a second set of openings 170b, a third set of openings 170c, and a fourth set of openings 170d, which may be similar to the sets of the third plurality of openings 166 as described.

The band segment 150 may include a fifth plurality of openings 174 spatially located in the elongate or longitudinal direction between the first end 168 and the second end 172 of the band segment. The fifth plurality of openings 174 may be positioned along a longitudinal axis of the band segment 150. The fifth plurality of openings 174 may be spaced at intervals such that they align with openings from the first plurality of openings 162 and the second plurality of openings 164. For example, an opening from each of the first plurality of openings 162, the second plurality of openings 164, and the fifth plurality of openings 174 may be aligned in a direction generally perpendicular to the longitudinal axis of the band segment. The fifth plurality of openings 174 may assist in connecting adjacent band segments 150 together as further described.

Any of the openings 162, 164, 166, 170, 174 may be cylindrical as shown, or other shapes such as elongated holes or slots, polygonal openings, other shapes, or combinations thereof.

FIGS. 8A and 8B illustrate respectively front and rear views of an example method of coupling two band segments 150A, 150B together using one or more connectors 153. The band segments 150A, 150B and connectors 153 may be used with the deployment system 104 of FIG. 1. The method described with reference to FIGS. 8A and 8B may be used for band segments 150 that have thicknesses of 0.25 millimeters (mm) or greater. The connector 153 may be used to attach the band segments 150 together. The connector 153 may span across surfaces of adjacent band segments 150A, 150B. The use of the connector 153 to couple the band segments 150A, 150B together may be advantageous as the connector 153 may allow for the decoupling of the band segments 150A, 150B and easy replacement or fixing of the individual band segments 150A, 150B.

The connector 153 may be a planar structure connecting the end-to-end, adjacent band segments 150A, 150B together. The connector 153 may be a doubler or stiffener. The connector 153 may be shorter in the longitudinal direction than the adjacent band segments. FIG. 8A shows the connector 153 located on front surfaces of the band segments 105A, 150B, which may be radially inward surfaces or radially outward surfaces as stowed and/or after deployment. FIG. 8B shows a rear view of the interface but prior to attachment of a second connector on the rear surfaces, which may be radially outward or radially inward surfaces as stowed and/or after deployment. There may be two of the connectors 153 on the opposing front and rear surfaces of the band segments 150A, 150B. The band segments 150A, 150B may be coupled together by two of the connectors 153. The connectors 153 may be pre-installed prior to storing of the elongate band 116 in the storage reel 112. The one or more connectors 153 may provide, in combination with underlying features of the band segments such as stiffness reduction windows, continuous stiffness along a deployment axis of the deployable mast 100 without compromising the structural integrity of the deployable mast 100.

Each band segment 150A, 150B may incorporate the features described with reference to any other band segment herein, such as the band segment 150. The first end 168 of the band segment 150A may abut and be coupled to the second end 172 of the band segment 150B with little or no space therebetween. The first end 168 of the band segment 150A may be positioned adjacent or next to the second end 172 of the band segment 150B, in some embodiments with a gap therebetween.

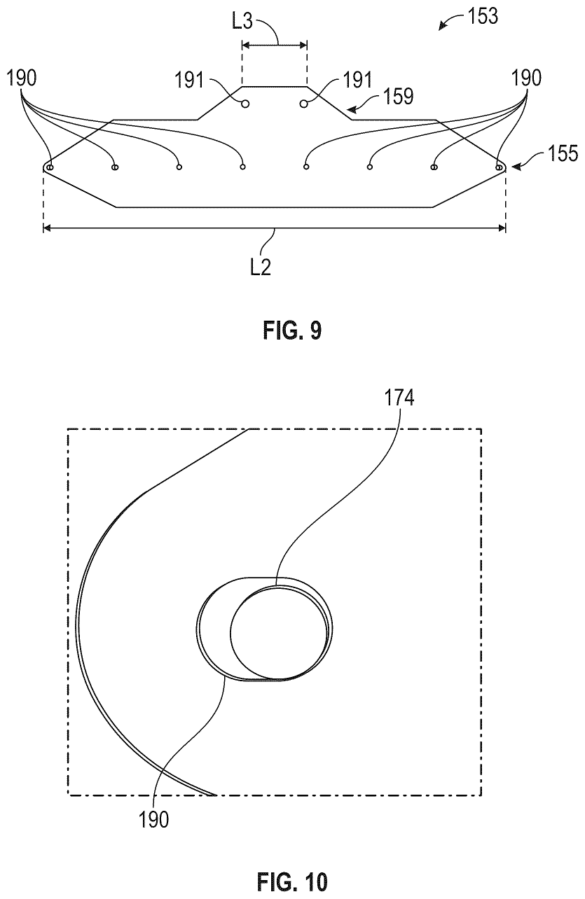

FIG. 9 illustrates the example connector 153 in isolation. The connector 153 may be used with any of the deployment systems herein, such as the deployment system 104 of FIG. 1. The connector 153 may include a first portion 155 and a second portion 159. The first portion 155 may extend a longitudinal length L2 from opposing ends. The second portion 159 may extend transversely from an edge of the first portion 155. The second portion 159 may be positioned at a generally central location along the length L2 of the first portion 155. The second portion 159 may have an upper edge that extends a length L3. The length L3 may be less than the length L2.

The connector 153 may include a first plurality of openings 190. The openings 190 may be positioned in the first portion 155. The first plurality of openings 190 may be positioned in a generally linear arrangement from the first longitudinal end of the connector 153 to the second longitudinal end of the connector 153. The first plurality of openings 190 may be spaced at intervals. The spacing of the openings 190 may correspond to the spacing of the fifth plurality of openings 174 at opposing ends of adjacent band segments 150 (see, e.g., FIG. 7). The first plurality of openings 190 and the fifth plurality of openings 174 may receive protrusions, such as rivet assemblies or other fasteners, therethrough when coupling adjacent band segments 150 together. There may be eight of the openings 190 as shown, or more than one, more than two, more than three, or from five to ten of the openings 190.

In some embodiments, the first plurality of openings 190 may have varying shapes and sizes. As shown in FIG. 10, the opening 190 of the first plurality of openings 190 may have an elongated length forming a slot-like shape. The length may be longer than the transverse width of the opening 190. Other openings of the first plurality of openings 190 may have slotted or circular shapes.

Openings 190 closer to a central location along the length L1 of the connector 153 may have a more circular shape, whereas openings of the plurality of openings 190 positioned at or near the ends of the connector 153 may have a more slot-like shape. The lengths of the elongated openings 190 may increase from the central location along the length L1 toward the ends of the connector 153. Thus the slot length may be longest in first openings 190 near the ends of the connector 153, and the next adjacent second openings 190 in the inward direction may have a slot length shorter than that of the first openings 190, the next adjacent third openings 190 in the inward direction may have a slot length shorter than that of the second openings 190, etc. The central-most openings 190 may have the smallest length elongation or be circular.

Pairs of openings, of the openings 190 and the corresponding openings 174 of the elongate band 116, may be different shapes. For example, a first opening 190 may be an elongated slot and the corresponding opening 174 of the elongate band 116 may be circular. The slot-like shape of some of the openings 190 may allow for more flexibility in assembly of the elongate band 116 formed by multiple band segments 150 coupled together with the connectors 153. For example, the slot shape of at least some of the openings of the first plurality of openings 190 may allow the connector 153 to slide along the band segment 150 when coupled thereto. This may be beneficial when the elongate band 116 is stowed in a spiral shape in the storage reel 112. The arrangement may allow for the connector 153 to move as the elongate band segments 150 deploy from the curled, spiral shape in the storage reel 112 into the helically-wound, cylindrical shape as deployed.

The connector 153 may include a second plurality of openings 191 positioned in the second portion 159. The plurality of openings 191 may be circular, or other shapes. The second plurality of openings 191 may be located, sized and/or shaped to generally align and correspond to either the first plurality of openings 162 or second plurality of openings 164 of the band segment 150. The second plurality of openings 191 and the first plurality of openings 162 of the band segment 150 or the second plurality of openings 164 may receive protrusions, for example fasteners such as rivet assemblies, when coupling the connector 153 to adjacent band segments 150. The second plurality of openings 191 may be spaced such that a first opening 191 may align with a corresponding opening 162 or 164 of the first band segment 150A, and a second opening 191 may align with a corresponding opening 162 or 164 of the second band segment 150B. Each of the openings in the connector 153 may extend completely through the connector 153.

To couple the first band segment 150A and the second band segment 150B together, the first connector 153A may be coupled to the first surface 151A of the band segment 150A and to the first surface 151B of the band segment 150B. The first surfaces 151A, 151B may be radially inward or radially outward surfaces as stowed or deployed. The first connector 153A may be coupled with the band segments 150A, 150B using the protrusions described herein.

The first connector 153A may be referred to as an inner connector as it faces an inner area of the deployable mast 100 when in the stowed and deployed configurations. The first plurality of openings 190A of the first connector 153A may be aligned with the fifth plurality of openings 174A, 174B of the band segments 150A, 150B (see, e.g., FIG. 8A). The second plurality of openings 191A may be aligned with the first plurality of openings 162A, 162B of the band segments 150A, 150B. Protrusions, for example fasteners such as rivet assemblies, as further described herein, may be used to couple the openings together.

The first connector 153A may be positioned such that the second portion 159A of the connector 153A overlaps with the chamfered corners 154A, 154B of the band segments 150A, 150B. The chamfered corners 154A, 154B may create an empty space that overlaps with the second portion 159A. The empty space may help reduce the stiffness at the joint between band segments 150A, 150B such that the elongate band 116 maintains a generally consistent stiffness along the length of the elongate band 116.

A second connector 153B may be coupled to the second surface of the first band segment 150A and the second surface of the second band segment 150B. As the first surfaces 151A, 151B of the band segments 150A, 150B are visible (see FIGS. 8A and 8B), only portions of the second connector 153B are visible through the openings in FIG. 8B and near the chamfered corners 158A, 158B.

FIGS. 11A and 11B illustrate, respectively, radially inner and outer connectors 153A, 153B coupling two band segments 150A, 150B together in a non-deployed configuration, such as a stowed configuration. FIGS. 11C and 11D illustrate, respectively, outer and inner connectors 153B, 153A coupling two band segments 150A, 150B in a deployed configuration. Any of the features of FIGS. 11A-11D may be used with any of the deployment systems described herein, such as the deployment system 104.

The second connector 153B may be referred to as an outer connector as it faces an area external to the deployable mast 100 when in the deployed configuration. The first plurality of openings 190 of the second connector 153B may be aligned with the fifth plurality of openings 174A, 174B of band segments 150A, 150B and the first plurality of openings 190A of the first connector 153A. The second plurality of openings 191 may be aligned with the second plurality of openings 164A, 164B of the band segments 150A, 150B. Fasteners such as rivet assemblies, as described herein, may be used to couple the openings together.

The second connector 153B may be positioned such that the second portion 159 of the second connector 153B overlaps with the chamfered corners 158A, 158B of the band segments 150A, 150B. The chamfered corners 158A, 158B may create an empty space that overlaps with the second portion 159. The empty space may help reduce the stiffness at the joint between band segments 150A, 150B. An edge of the second portion 159A of the first connector 153A may be aligned with the first lateral edges 156A, 156B of the band segments 150A, 150B. An edge of the second portion 159 of the second connector 153B may be aligned with the second lateral edges 160A, 160B of the band segments 150A, 150B. The first and second connectors 153A, 153B may therefore be “flipped” relative to each other with the respective second portions 159 facing opposite directions.

The first connector 153A and the second connector 153B may have different thicknesses. For example, the first connector 153A (e.g., an inner connector) may have a lesser thickness than the second connector 153B (e.g., an outer connector). The difference in thickness between the first connector 153A and the second connector 153B may account for a need for a reduced change in thickness as the deployable mast 100 deploys to a deployed configuration. In some embodiments, the first connector 153A may be on a radially inner side of the band segments 150A, 150B and be thinner or thicker than the second connector 153B on a radially outer side of the band segments 150A, 150B.

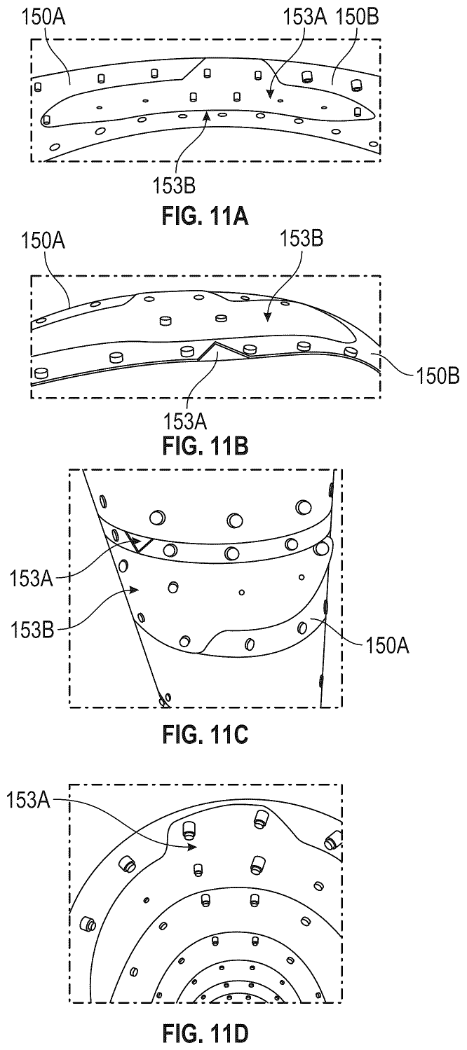

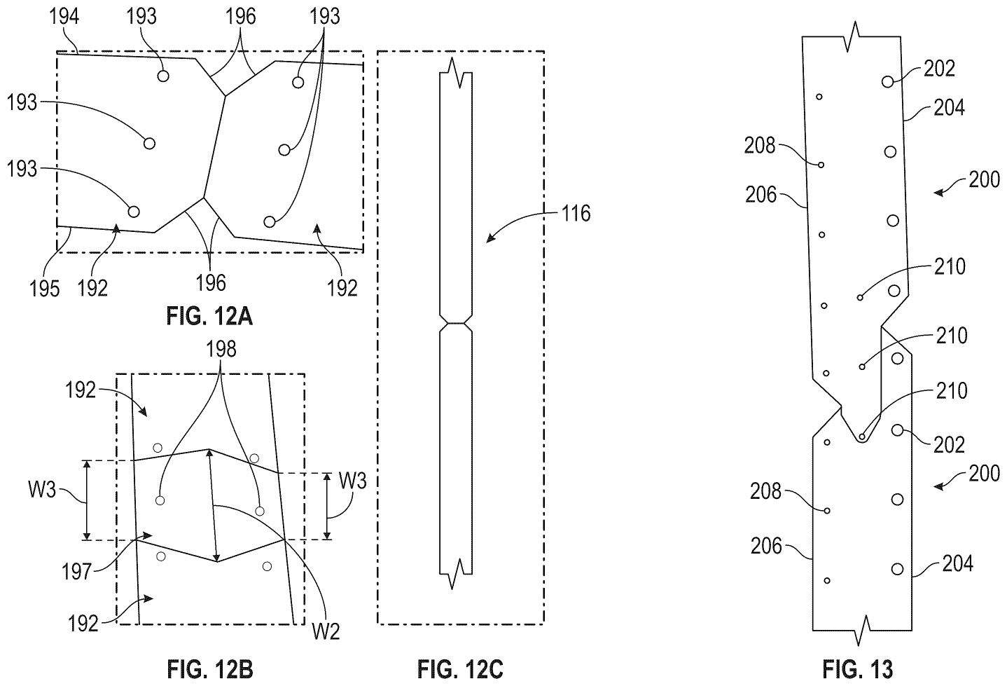

FIGS. 12A-12C illustrate example features and methods for coupling two band segments 192 together. The features and methods of FIGS. 12A-12C may be used with any deployment systems herein, such as the deployment system 104. The band segments 192 may incorporate features as described with reference to other band segments here (e.g., band segments 150, band segments 200, etc.). The methods described with reference to FIGS. 12A-12C may be used for band segments 192 that have a thickness of 0.25 mm or greater. A connector 197) may be used to attach the band segments 192 together. The connector 197 may provide substantially uniform stiffness along a deployment axis of the deployable mast 100 without compromising the structural integrity of the deployable mast 100.

The band segments 192 may be coupled together via one or more connectors 197 as shown in FIG. 12B. FIG. 12C illustrates a portion of the elongate band 116 that may be formed by the plurality of band segments 192. Each band segment 192 may include a plurality of openings 193, such as holes, at each end of the band segment 192. The plurality of openings 193 may be arranged linearly from or near a first lateral edge 194 to or near a second, opposite lateral edge 195 of the band segment 192. The band segments 192 may include chamfered corners 196. The chamfered corners 196 may allow for a reduced stiffness within the band segments 192 at the location where adjacent ends of the band segments 192 are joined by the connector 197, which may provide additional stiffness at that location.

To couple adjacent band segments 192 together, adjacent ends of two band segment 192 may be positioned next to each such that they are aligned, abutted, or slightly overlapped. The connector 197 may be positioned such that the connector 197 overlaps with the adjacent ends of the band segments 192. In some embodiments, two connectors 197 may be used. A first connector 197 may connect first surfaces of two band segments 192 together, while a second connector 197 may connect second surfaces, opposite the first surfaces, of the two band segments 192 together, as described herein, for example with respect to FIGS. 7-11D. The connector(s) 197 may have a width W2 at a generally central location of the connector 197. The width W2 may taper outward and away from the generally central location in two lateral directions to laterally outer widths W3. Width W2 may extend along a longitudinal axis of the band segments 192. Widths W3 may be aligned with the lateral edges 194, 195 of the band segments 192. The change in width may allow for reduced stiffness at the location where adjacent ends of the band segments 192 are joined by the connector 197.

The connector 197 may include a plurality of openings 198, such as holes. The plurality of openings 198 may be positioned in the connector 197 such that the plurality of openings 198 align with the plurality of openings 193 in the band segments 192. Protrusions, for example fasteners such as rivet assemblies, may be used to couple the openings 193, 198 of the band segments 192 and the connector 197 together to form a continuous band. The protrusions and methods of installing protrusions embodied as rivet assemblies are described in further detail herein.

FIG. 13 illustrates additional example features and methods of coupling two band segments 200 together to form the elongate band 116. The method shown in FIG. 13 can couple the two band segments 200 together without the use of a connector. Overlapping ends of the band segments 200, as described below, may eliminate the need for a connector. The band segments 200 may incorporate features as described with reference to other band segments here (e.g., band segments 150, band segments 192, etc.). The method and features illustrated in FIG. 13 may be used when the band segments 200 are thin sheet metal bands. For example, the band segments 200 may have a thickness of less than about 0.25 mm or no greater than about 0.010 inches. The band segments 200 may be overlapped without a compromise in mechanism alignment during deployment and retraction of the deployable mast 100.

Each band segment 200 may include a first plurality of openings 202, such as holes, positioned along a first lateral edge 204 and a second plurality of openings 206, such as holes, positioned along a second lateral edge 208. In some embodiments, each band segment 200 may include a third plurality of openings 210 positioned along a longitudinal axis of the band segment 200. The third plurality of openings 210 may only be positioned at or near longitudinal ends of the band segment 200. Each of the first plurality of openings 202 may be configured to couple with a portion of a protrusion, for example a fastener head such as a rivet head (as described in more detail herein, for example with reference to FIGS. 15A-E). Each of the second plurality of openings 206 may be configured to receive a portion of a protrusion, for example a fastener shaft such as a rivet shaft extending from the rivet head (as described in more detail herein, for example with reference to FIGS. 15A-E) during deployment of the deployable mast 100. The third plurality of openings 210 may be configured to receive protrusions to couple adjacent band segments 200 together. For example, adjacent ends of adjacent band segments 200 may be overlapped such that sets of the third plurality of openings 210 from each band segment 200 align. Protrusions may then be installed to join the aligned sets of the third plurality of openings 210. Additional details on protrusions and example fasteners such as rivet assemblies and methods of installation are described herein, for example with reference to FIGS. 15A-E.

### Example Methods of Joining Adjacent Edges of the Elongate Band

As the deployment system 104 deploys the elongate band 116 from the stowed configuration to the deployed configuration to form the deployable mast 100, adjacent edges of the elongate band 116 may be joined together. In some embodiments, adjacent edges may be temporarily joined (e.g., the elongate band is capable of being retracted back into the stowed configuration) or permanently joined (e.g., the elongate band cannot be retracted back into the stowed configuration).

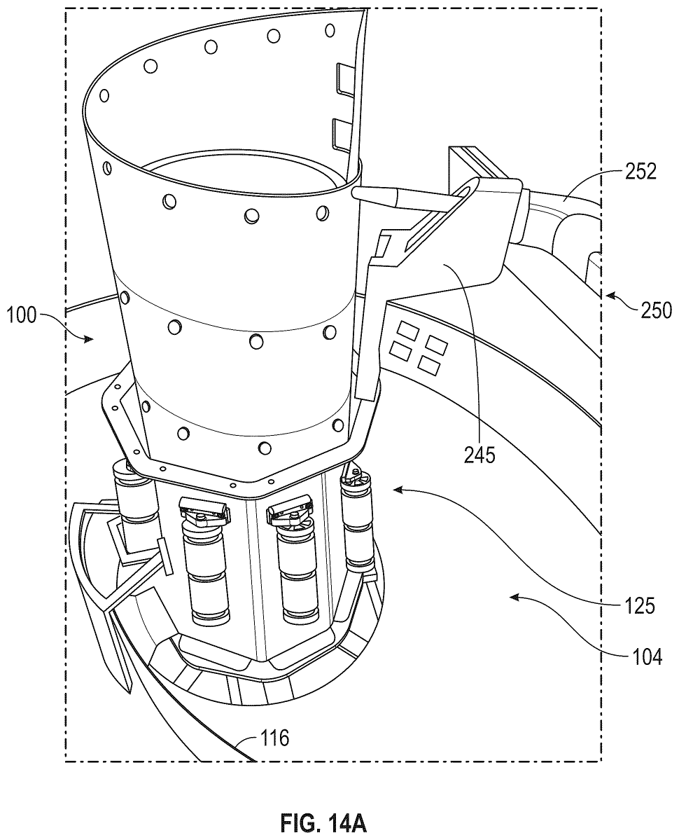

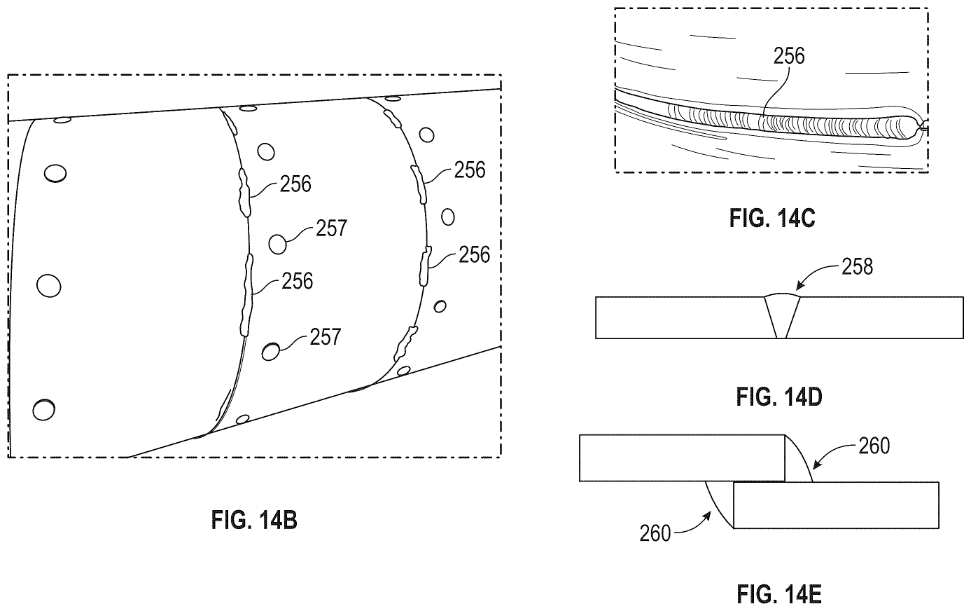

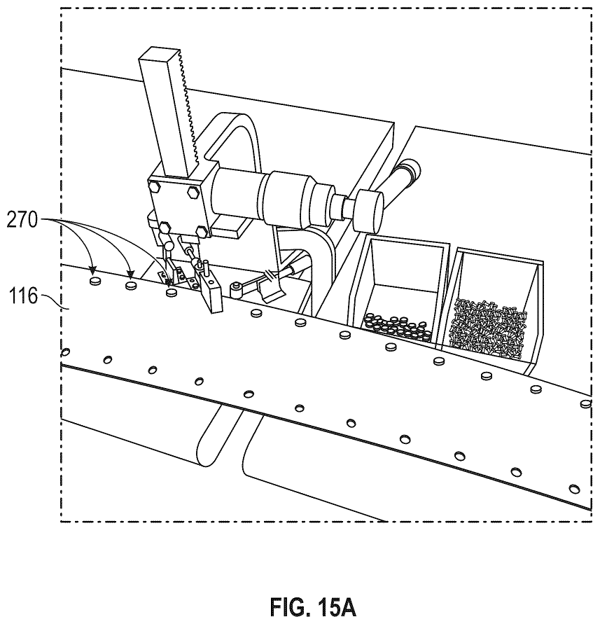

FIGS. 14A-14E illustrate various features and methods for joining adjacent edges of the elongate using a welding system 250. The welding system 250 may be used with any of the deployment systems described herein, such as the deployment system 104 and any other systems shown and described with respect to FIGS. 1-5B. The welding system 250 may be used with any of the elongate bands, band segments, connectors, etc. as described herein, such as those shown and described with respect to FIGS. 6A-13.

As shown in FIG. 14A, the welding system 250 may include a welder 252. The welder 252 is configured to weld together adjacent edges of the elongate band 116. There may be one or more of the welders 252. The welder 252 may be a laser welder. The welder 252 may create a lap weld. The welder 252 may be a rolling resistive seam welder or a high-powered laser to create a weld seam.

Other types of welders may be used. The welder 252 may use tungsten inert gas where electrical pulses are sent through a Tungsten welding gun. A filler wire may be fed to the joint separate from the gun. An inert shield gas such as argon may be fed through the gun while welding. The welder 252 may use metal inert gas, which may be similar to the Tungsten welding gun but where filler wire is fed through the gun. The welder 252 may use arc welding where sparking heats the material to generate heat for welding. The welder 252 may use resistance welding where resistance heats the metal while a charge is passed through. A form of resistance welding, spot welding, may be implemented. The welder 252 may be an electron beam welder that uses powder. The welder 252 may be a brazing welder using flux and an aluminum alloy with a lower melting point to produce a metallic bond.

In some embodiments, the welder 252 may use friction stir welding, ultrasonic stir welding, laser welding, electron beam welding, low-pressure plasma arc welding, or consumable electrode welding. For example, the welder 252 may use frictional heating with forging pressure to produce high-strength bonds between the adjacent edges of the elongate band 116. In some embodiments, a rotating pin tool may soften, stir, and forge a bond between the adjacent edges to form a welded joint. In some embodiments, a stir rod may stir plasticized abutting surfaces of the adjacent edges using heat generated by an induction coil.

The welder 252 may be coupled to the deployment system 104 via a support 254. In some embodiments, the support 254 may be movably, for example rotatably, coupled to the housing 125. In some embodiments, the support 254 may be coupled to the rotating member 128 of the drive system 126 and rotate therewith. The welding system 250 may be configured to move or rotate the welder 252 to weld together adjacent edges of the elongate band 116 as the elongate band 116 transitions from the stowed configuration to the deployed configuration. The welder 252 may be moved to track adjacent edges of the elongate band 116 as the elongate band 116 transitions from the stowed configuration to the deployed configuration in order to weld the adjacent edges together. In some embodiments, the welder 252 may be moved or rotated about the longitudinal axis of the deployable mast 100 as it is deployed. In some embodiments, the welder 252 may remain axially stationary in the same vertical position (e.g., the welder 252 may not move up and down along the longitudinal axis of the deployable mast 100).

The welder 252 may be configured to rotate in a first rotational direction about the longitudinal axis of the deployable mast 100 while welding together adjacent edges of the elongate band 116. The welder 252 may be configured to rotate in a second rotational direction, opposite the first rotational direction, about the longitudinal axis of the deployable mast after completing a weld line or a portion of a weld line. The welder 252 may not be welding when rotating in the second rotational direction. In some embodiments, the welder 252 may only complete a partial rotation about the outer perimeter of the deployable mast 100 when rotating in the first rotational direction. In some embodiments the welder 252 may continuously rotate in the same direction more than one full revolution about the longitudinal axis.

The welding system 250 may include one or more sensors configured to monitor alignment of the adjacent edges of the elongate band 116 as the adjacent edges are being welded and may correct the positioning of the welder 252 or the elongate band 116 as needed to ensure the adjacent edges are being joined. In some embodiments, the one or more sensors may be positioned on the welder 252. The one or more sensors can be a thermal camera for monitoring the temperature when welding adjacent edges. The thermal camera may monitor the temperature and provide an alert if the temperature falls outside a predetermined temperature range. The thermal camera may be positioned such that the thermal camera is directed to the location of the welding.

As shown in FIG. 14B, the welder 252 may form a plurality of non-continuous weld lines 256 when welding adjacent edges of the elongate band 116. In some embodiments, the welder 252 may form a single continuous weld line 256, as shown in FIG. 14C. The weld line(s) may provide addition support or stiffness to the deployable mast 100. The welder 252 may be used to form butt joints 258 or lap joints 260. For example, the elongate band 116 may be deployed by the deployment system 104 such that adjacent edges of the elongate band 116 are positioned next to each other or abutting each other, as shown in FIG. 14D, or the elongate band may be deployed by the deployment system 104 such that portions of the adjacent edges overlap, as shown in FIG. 14E. In some embodiments, adjacent edges may also or alternatively be joined using protrusions, for example fasteners such as rivet assemblies as described herein.

FIGS. 15A-E illustrate example features and methods for installing protrusions such as the fasteners embodied as rivet assemblies 270. Other fasteners may be used, such as bolt and nut, a deformable shaft, a pin, etc. The rivet assemblies 270 are thus merely one example. The features and methods shown and described with respect to FIGS. 15A-15E may be used with any of the systems described herein, such as those shown and described with respect to FIGS. 1-14E.

As shown in FIGS. 15A-E, in some embodiments, the protrusions may be embodied as rivet assemblies 270. The rivet assemblies 270 may be configured to extend from a first and/or second surface of any of the elongate bands, band segments, and connectors described herein. The rivet assemblies 270 described herein may be used to join adjacent edges of the elongate band 116, to join adjacent ends band segments (e.g., band segments 150, 192, 200), or to join connectors (e.g., connectors 153, 197) to ends of band segments.

FIG. 15A illustrates rivet assemblies 270 being installed on the elongate band 116 (or a band segment 150 192, 200). The same or similar methods for installing the rivet assemblies 270 on the elongate band 116 may be used to install the rivet assemblies 270 to join the connectors 153, 197 to band segments 150, 192, 200. The rivet assemblies 270 may be pre-installed prior to storing the elongate band 116 in the storage reel 112. The rivet assemblies 270 may include a rivet 271 and a spacer 272, as shown in FIGS. 15B-15E. The rivet assemblies 270 may be pre-installed to join the band segments and connectors prior to the elongate band 116 being stowed in the storage reel 112.

FIGS. 15B and 15C illustrate an example method of installing a rivet assembly 270. FIGS. 15B and 15C will describe the rivet assembly 270 being installed to the band segment 150 but it should be understood that the methods may apply to any installation of rivet assemblies described herein.

FIG. 15B illustrates an embodiment of the rivet 271 and the spacer 272 in an unassembled configuration. As shown the rivet 271 and the spacer 272 have not yet been joined to the band segment 150. The rivet 271 has been inserted into a hole of the first plurality of openings 162 of the band segment 150. The rivet 271 may be inserted into the opening 162 such that a rivet head 273 either rests within the opening 162, partially rests within the opening 162, or rests against a first surface of the band segment 150. A rivet shaft 274 may be inserted through the opening 162 such that the rivet shaft 274 extends through the hole and past a second surface of the band segment 150. The rivet shaft 274 may have a first diameter D1 and a second diameter D2. The first diameter D1 may be smaller than the second diameter D2. The first diameter D1 may allow for a clearance between the rivet shaft 274 and the opening 162. The second diameter D2 may be closer in size or the same size as the diameter of the opening 162. The second diameter D2 may allow for a press fit or interference fit between the rivet shaft 274 and the opening 162.

Once the rivet 271 is inserted through the opening 162, the spacer 272 may be positioned about the rivet shaft 274. The spacer 272 may have a constant inner diameter or a varying inner diameter that corresponds to the diameters D1, D2 of the rivet shaft 274. The rivet shaft 274 may have a height that exceeds a height of the spacer 272 such that a surface of the rivet shaft 274 extends above a surface of the spacer 272. After placement of the spacer 272, a press 275 may be used to secure the rivet assembly 270 to the band segment 150.

FIG. 15C illustrates an embodiment of the rivet assembly 270 after the press 275 applies a force to the rivet assembly 270. As shown in FIG. 15C, the press 275 has applied a force such that the rivet shaft 274 has compressed and expanded outward to secure the spacer 272 and the rivet 271 together. The force applied by the press 275 may also compress the thickness of the rivet head 273. In some instances, the rivet head 273 may become flush with the first surface of the elongate band 116. The spacer 272 may remain a part of the rivet assembly 270. In some embodiments, the spacer 272 may be removed after the press 275 has compressed and expanded the rivet shaft 274.

FIGS. 15D and 15E illustrate another example method of installing a protrusion embodied as a rivet assembly 270. FIGS. 15D and 15E will describe the rivet assembly 270 being installed to the band segment 150 but it should be understood that the methods may apply to any installation of rivets described herein.

FIG. 15D illustrates an embodiment of the rivet 271 and the spacer 272 in an unassembled configuration. As shown the rivet 271 and the spacer 272 have not yet been joined to the band segment 150. The rivet 271 has been inserted into a hole of the first plurality of openings 162 of the band segment 150. The rivet 271 may be inserted into the opening 162 such that a rivet head 273 either rests within the opening 162, partially rests within the opening 162, or rests against a first surface of the band segment 150. A rivet shaft 274 may be inserted through the opening 162 such that the rivet shaft 274 extends through the hole and past a second surface of the band segment 150. The rivet shaft 274 may have a constant diameter D3. The diameter D3 may allow for a press fit or interference fit between the rivet shaft 274 and the opening 162.

Once the rivet 271 is inserted through the opening 162, the spacer 272 may be positioned about the rivet shaft 274. The rivet shaft 274 may have a height that exceeds a height of the spacer 272 such that a surface of the rivet shaft 274 extends above a surface of the spacer 272. After placement of the spacer 272, a press 275 may be used to secure the rivet assembly 270 to the band segment 150.

FIG. 15E illustrates an embodiment of the rivet assembly 270 after the press 275 applies a force to the rivet assembly 270. As shown in FIG. 15E, the press 275 has applied a force such that the rivet shaft 274 has compressed and expanded outward to secure the spacer 272 and the rivet 271 together. The force applied by the press 275 may also compress the thickness of the rivet head 273. In some instances, the rivet head 273 may become flush with the first surface of the elongate band 116. The spacer 272 may remain a part of the rivet assembly 270. In some embodiments, the spacer 272 may be removed after the press 275 has compressed and expanded the rivet shaft 274.

Methods of joining adjacent edges of the elongate band 116 using rivet assemblies 270 will now be described with reference to band segments 150, however, the methods described should be understood to apply to any band segments described herein.

The rivet assemblies 270 may be installed in the first plurality of openings 162 of the band segment 150. The rivet assemblies 270 may be installed prior to stowing the elongate band 116 formed of the band segments 150 in the storage reel. After installation of the rivet assemblies 270 with the first plurality of openings 162, the rivet heads 273 and the spacers 272 may create protrusions on one or both sides of the band segment 150. in some embodiments, the spacers 272 may be configured to interact with the track 134 of the rotating member 128 of the drive system 126. The spacers 272 may travel in the track 134 as the elongate band 116 transitions from the stowed configuration to the deployed configuration. In some embodiments, the spacers 272 may be removed and the compressed and expanded portion of the rivet shaft 274 may interact with and travel along the track 134. The track 134 may assist in controlling the helical deployment of the elongate band 116.

As the elongate band 116 is fed from the stowed configuration, adjacent edges of the elongate band 116 may overlap when deployed into the helical configuration. The adjacent of the elongate band 116 may overlap such that the rivet heads 273 spaced along a first portion of the first lateral edge 156 are received in corresponding openings of the second plurality of openings 164 positioned along a second portion of the second lateral edge 160. The receiving of the rivet heads 273 in corresponding openings 164 joins adjacent edges of the elongate band 116 together. In some embodiments, the rivet heads 273 may be press fit or interference fit into the corresponding openings of the second plurality of openings 164. In some embodiments, the adjacent edges of the elongate band 116 may also be welded together as described above, while simultaneously being joined by receiving the rivets heads 273 into the corresponding openings of the second plurality of openings 164. The passive feeder 123, described above with reference to FIG. 5B can assist in ensuring alignment of the rivet heads 273 and the openings 164.

In retracting the deployable mast 100 back to the stowed configuration, the coupling between the rivet heads 273 and the corresponding openings 164 may disengage to allow the elongate band 116 to return to the stowed configuration. The rivet assemblies 270 can be withdrawn from the openings 164 while feeding the elongate band 116 back to the stowed configuration. The motor 140 may operate the drive system 126 in the opposite direction causing the elongate band 116 to retract.

The deployable mast 100 may deflect in the deployed configuration without any external load applied. The amount of deflection at the tip of the deployable mast 100 may define a radius of slop, which is a circular envelope defining the possible final location of the deployed tip. The slop may be a result of the clearance between the protrusions (such as the rivet heads 273) and the corresponding openings (such as the second plurality of openings 164), which may be elongated openings such as slots. The radius of slop may be calculated based on a radius of curvature (R_{c}) of the deployed mast and the elongated length or height of the mast (H). The radius of curvature may be calculated using a pitch of the mast (“P”), a diameter of the mast (“D”), and a clearance between the protrusion and a corresponding opening (“c”). The pitch of the mast may be the helix height, such as the longitudinal length of one complete helix turn of the elongated band. In some embodiments, the clearance may be between 0.01 and 0.1 mm, between 0.02 and 0.05 mm, or about 0.0254 mm.

$$Radius of Curvature = \frac{P \times D}{c}$$

$$Radius of Slop = Rc \times ( 1 - cos ( \frac{H}{Rc} ) )$$

The use of welding may increase the stiffness of the mast and thus decrease the deflection of the deployable mast 100 when a given force is applied to the deployable mast 100 in the deployed configuration. The welded mast may improve the stiffness of a non-welded mast more than 50%, more than 75%, more than 100%, or more than 150%. In some embodiments, for a deployable mast having a length of 1.651 meters, an outer diameter of 200 mm, a thickness of the elongate band being 0.635 mm, and a load applied at the tip of the deployed mast: for a load of about 50 Newtons, the non-welded and welded masts may deflect respectively no more than 0.009 meters versus no more than 0.005 meters; for a load of about 100 Newtons, no more than 0.018 meters (non-welded) versus no more than 0.011 meters (welded); and for a load of about 150 Newtons, no more than 0.026 meters (non-welded) versus no more than 0.016 meters (welded).

The mass of the payload(s) 108 and of the masthead being supported by the deployable mast 100 may also impact the radial deflection of the deployable mast 100. As mass of the payload 108 increases, the radial deflection may also increase. For example, using a 1.28 meter deployable mast having an outer diameter of 200 mm as an example, a payload and masthead mass of about of about 0.338 kilograms (kg) may result in an average radial deflection of about 0.175 meters, while a payload and masthead mass of about 1.138 kg may result in an average radial deflection of between 0.200 and 0.225 meters.

In some embodiments, the deployed mast may result in a structure having a frequency in a lunar gravitational environment of at least 0.1 Hz, at least 0.2 Hz, or at least 0.5 Hz. On earth, the deployed mast may result in a structure having a frequency of at least 0.3 Hz, at least 0.6 Hz, at least 1 Hz, at least 2 Hz or at least 3 Hz. Further, the deployed mast may result in a structure having a stiffness of at least 15,000 N-m/Rad, of at least 17,500 N-m/Rad, or of at least 20,000 N-m/Rad. The total static deflection of the deployed mast may be no more than 1 meter, no more than 0.75 meters, no more than 0.5 meters, or no more than 0.25 meters, under a load of about 26.5 N (Newtons). Such stiffnesses and deflections may apply to masts having an outer diameter of at least 150 mm and/or no more than 200 mm, a height of at least 15 meters, and a thickness of the elongate band of about 2 mm.

### Example Macro Application of the Deployment System

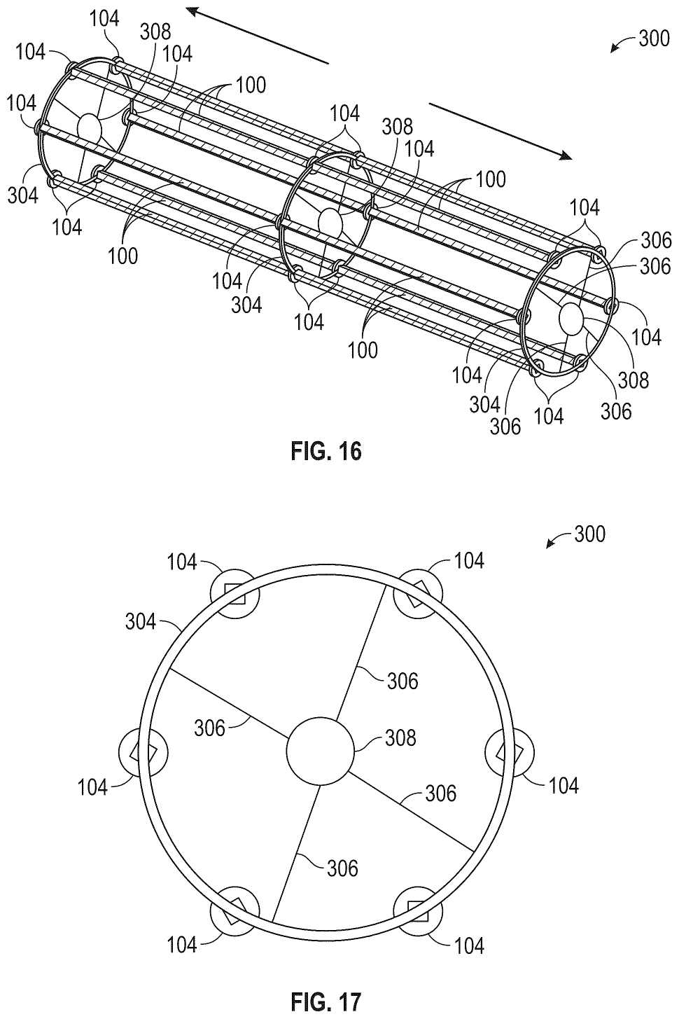

FIGS. 16 and 17 illustrate respectively perspective and end views of an embodiment of a deployable structure 300. Any of the systems and methods described herein may be used with the deployable structure 300, such as the systems and methods of FIGS. 1-15E. For example, the deployable structure 300 may be a macro structure formed using multiple deployment systems 104.

As shown in FIG. 17, the deployable structure 300 may be pre-connected and stored in a stowed or undeployed state. For example, in the space context, the deployable structure 300 may be stowed in a launch configuration for sending to space. This may be advantageous as it may reduce the size of the structure being sent to space, while also allowing for larger space habitats to be built using more efficient processes.

The deployable structure 300 may have a structural base formed of a plurality of structural bases 304 and a plurality of the deployable masts 100. The bases 304 may be ring structures, but the structural bases 304 are not limited to having a ring shape and may be circular, polygonal, other rounded shapes, or combinations thereof. The structural base 304 may be a closed shape as shown, such as a complete ring, or a discontinuous, open structure such as horseshoe, semi-circle, or other shape.

FIG. 16 illustrates an embodiment of the deployable structure 300 having three bases 304 connected via the plurality of deployable masts 100. While three structural bases 304 are shown, any number of structural bases 304 may be coupled together. While six deployable masts 100 are shown coupling adjacent structural bases 304, any number of deployable masts 100 may be used. The deployable structure 300 may be a large structure. For example, in some instances the deployable structure 300 may have a longitudinal length of at least 30 meters, at least 40 meters, at least 50 meters, at least 60 meters, at least 70 meters, at least 80 meters, at least 90 meters, or at least 100 meters. In some embodiments, the structural bases 304 may have a width (e.g. a diameter for circular shapes) of at least 3 meters, at least 4 meters, at least 5 meters, at least 6 meters, at least 7 meters, at least 8 meters, at least 9 meters, at least 10 meters, at least 11 meters, at least 12 meters, at least 13 meters, at least 14 meters, at least 15 meters, at least 20 meters, at least 30 meters, at least 40 meters, or at least 50 meters. The deployable structure 300 may be any size and is not limited in size. As discussed above, the deployable masts 100 can have an indefinite length in a zero-gravity environment. The deployable masts 100 can be scaled for the desired size of the deployable structure 300.

In the stowed state, the undeployed deployable masts 100 may be connected at a first end to a first structural base 304 and at a second end to a second structural base 304. As shown in FIG. 17, two or more structural bases 304 may be coupled via a plurality of undeployed deployable masts 100. The deployable masts 100 may be circumferentially spaced about the structural bases 304. The structural bases 304 may be aligned such that only one structural base is visible in FIG. 17.

The plurality of deployable masts 100 may be deployed to form the deployable structure 300 shown in FIG. 16. Each deployable mast 100 may be coupled at a first end to a first structural base 304 and at a second end to second structural base 304. Each deployable mast 100 may be configured to helically and longitudinally deploy a respective band about respective axes to increase the distance between the first structural base 304 and the second structural base 304. As the deployable masts 100 deploy axially, as described herein, the first structural base 304 may move axially away from the second structural base 304. In some instances, the deployable masts 100 may deploy simultaneously such that all points along the first structural base 304 move away from the second structural base 304 at the same time (e.g., are the same distance away from the second structural base 304). The deployable masts 100 may longitudinally separate the first structural base 304 from the second structural base 304. This may result in the deployable structure 300 having a generally cylindrical shape.

In some embodiments, the deployable structure 300 may include a plurality of radially extending ribs 306. The radially extending ribs 306 may extend radially inward toward a longitudinal axis of the deployable structure 300. For example, the radially extending ribs 306 may be coupled at a first end to one of the structural bases 304 and extend inward toward a longitudinal axis of the structural base 304. In some embodiments, the radially extending ribs 306 may couple the structural bases 304 to a central hub 308. For example, the radially extending ribs 306 may be coupled at a first end to one of the structural bases 304 and coupled at a second end to the central hub 308. In some embodiments, the central hub 308 may be a longitudinally extending structure that extends through the deployable structure 300. The radially extending ribs 306 may provide additional support to the deployable structure 300 and be deployed before, after or while the deployable structure is formed.

In some embodiments, the radially extending ribs 306 may be deployable masts 100. The radially extending ribs 306 may be configured to helically and longitudinally deploy elongated bands as described herein radially inward from the structural base 304 towards the central hub 308. The radially extending ribs 306 may be configured to helically and longitudinally deploy radially outward from the central hub 308 towards the structural base 304.

### CONCLUSION

Various modifications to the implementations described in this disclosure will be readily apparent to those skilled in the art, and the generic principles defined herein may be applied to other implementations without departing from the spirit or scope of this disclosure. Thus, the disclosure is not intended to be limited to the implementations shown herein but is to be accorded the widest scope consistent with the claims, the principles and the novel features disclosed herein. The word “example” is used exclusively herein to mean “serving as an example, instance, or illustration.” Any implementation described herein as “example” is not necessarily to be construed as preferred or advantageous over other implementations, unless otherwise stated.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Additionally, other implementations are within the scope of the following claims. In some cases, the actions recited in the claims may be performed in a different order and still achieve desirable results.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. A system for deploying a deployable mast, the system comprising:
an elongate band comprising a plurality of openings and a plurality of protrusions; and
a deployment system configured to deploy the elongate band from a stowed configuration into a deployed, helical configuration along a longitudinal axis in which the plurality of protrusions extend into the plurality of openings.

2. The system of claim 1, wherein the plurality of openings and protrusions are configured to have a press fit or interference fit.

3. The system of claim 1, wherein each opening of the plurality of openings comprises a first bore having a first width and a second bore having a second width, the second width smaller than the first width.

4. The system of claim 1, wherein the plurality of protrusions are spaced along a first lateral side of the elongate band, and the plurality of openings are spaced along a second, opposite lateral side of the elongate band.

5. The system of claim 1, wherein the elongate band comprises a plurality of band segments, with adjacent band segments of the plurality of band segments coupled together by at least one connector.

6. The system of claim 5, wherein the at least one connector comprises openings and is coupled with the adjacent band segments via the plurality of protrusions of the adjacent band segments extending into the openings of the at least one connector.

7. The system of claim 1, wherein the elongate band comprises a plurality of band segments, adjacent band segments of the plurality of band segments coupled together by securing an end of a first band segment to an end of a second band segment, the end of the first band segment overlapped with the end of the second band segment.

8. The system of claim 1, wherein the elongate band is wound in a spiral when in the stowed configuration.

9. The system of claim 1, further comprising a welding system configured to weld adjacent edges of the elongate band as the elongate band deploys from the stowed configuration to the deployed configuration.

10. The system of claim 1, wherein the deployment system comprises a storage reel and a drive system having a rotating member, wherein the storage reel rotates at a first rate and the rotating member rotates at a second rate different than the first rate.

11. The system of claim 1, wherein the elongate band in the deployed configuration comprises a cylindrical portion extending no less than 20 meters.

12. The system of claim 1, wherein the elongate band comprises a plurality of band segments, wherein ends of the band segments comprise stiffness reduction windows.

13. A method of deploying a deployable mast, the method comprising:
feeding an elongate band from a stowed configuration to a deployed, helical configuration extending along a longitudinal axis; and
receiving a plurality of protrusions spaced along a first portion of the elongate band into a plurality of holes spaced along a second portion of the elongate band as the elongate band is fed into the deployed configuration.

14. The method of claim 13, further comprising press fitting or interference fitting the plurality of protrusions with the plurality of holes.

15. The method of claim 13, further comprising receiving the plurality of protrusions into a first bore of the plurality of holes that is wider than a second bore of the plurality of holes and then receiving the plurality of protrusions into the second bore.

16. The method of claim 13, further comprising withdrawing the plurality of protrusions from the plurality of holes while feeding the elongate band from the deployed configuration back to the stowed configuration.

17. The method of claim 13, further comprising rotating a storage reel at a first rate and rotating a rotating member of a drive system at a second rate different than the first rate to thereby feed the elongate band.

18. The method of claim 13, further comprising feeding the elongate band from a spiral, stowed configuration to the deployed configuration.

19. The method of claim 13, further comprising welding adjacent edges of the first portion of the elongate band and the second portion of the elongate band.

20. The method of claim 13, further comprising deploying the deployable mast to have a cylindrical portion extending along the longitudinal axis no less than 20 meters.
